(19) United States
(12) Patent Application Publication
(10) Pub. No.: US 2016/0112586 A1
(43) Pub. Date: Apr. 21, 2016

(54) IMAGE PROCESSING APPARATUS FOR PROCESSING MOVING IMAGE AND PRINT CONTROL APPARATUS FOR CONTROLLING LAYOUT, AND CONTROL METHOD AND STORAGE MEDIUM THEREOF

(71) Applicant: CANON KABUSHIKI KAISHA, Tokyo (JP)

(72) Inventors: Shigeyuki Miyazaki, Yokosuka-shi (JP); Yosato Hitaka, Tokyo (JP)

(21) Appl. No.: 14/878,241

(22) Filed: Oct. 8, 2015

(30) Foreign Application Priority Data
Oct. 15, 2014 (JP) 2014-210650
Jun. 22, 2015 (JP) 2015-124698

(51) Int. Cl. H04N 1/00; G11B 27/031; G06F 3/12

(52) U.S. Cl. CPC H04N 1/00251; H04N 1/00143; H04N 1/00169; H04N 1/00244; G06F 3/1206; G06F 3/1242; G06F 3/125; G06F 3/1288; G06F 3/1292; G11B 27/031

(57) ABSTRACT

A camera designates a moving image as a print target, specifies a material image to be printed based on composition information which is associated with the moving image of the print target and which includes information for specifying a plurality of original images used for generating the moving image, and transmits the material image and the composition information to a server PC to instruct the server PC to perform printing. The server PC determines layout of a page of a printed matter to be obtained as a result of printing according to the composition information and generates print data by arranging the material image based on the layout of the page.

### BACKGROUND OF THE INVENTION

1. Field of the Invention

The present invention relates to an image processing apparatus and a print control apparatus, and a control method and a storage medium thereof, and more particularly, to a print control apparatus for printing a moving image on a medium such as recording paper as a plurality of still images (for example, an album).

2. Description of the Related Art

In recent years, there has been an image pickup apparatus such as a digital camera which records motion of a subject from before a photographer presses a shutter button provided at the image pickup apparatus until immediately after the photographer presses the shutter button as a moving image separately from a still image shot when the shutter button is pressed. Through reproduction of the recorded moving image, the photographer, or the like, can know the atmosphere and situation at the time of shooting, which cannot be known only from the still image.

By this means, even a person who was not present at the shooting location can understand the atmosphere and situation at the time of shooting by viewing the moving image even if time has elapsed since the shooting.

Further, there is a case where a moving image is stored as a work, or a case where a still image and a moving image are edited to generate a new moving image as a digest version to be shown to another person. In most of such cases, typically, a computer such as a PC in which dedicated software for creating a moving image is installed is required.

Meanwhile, in recent years, an image pickup apparatus is known which can create a new moving image by editing a still image and a moving image. With such an image pickup apparatus, a user can create a digest version without using a computer when he is away from home, for example, while traveling. By this means, the user can look back on the travel so far with persons who travel with the user, such as family or friends in the course of the travel.

Further, the user can immediately know the atmosphere and situation at the time of shooting from the moving image recorded as a digest version by viewing the above-described moving image of the digest version.

However, a dedicated device is required to reproduce a moving image. If the user does not have a reproduction device for reproducing a moving image, it is impossible to reproduce the moving image, and, further, it is difficult for a person who is not used to manipulating the device to reproduce a moving image.

To solve such a problem, there is, for example, equipment which creates a moving image from a still image and accepts a printing instruction for particular effect in the moving image while reproducing the moving image (Japanese Laid-Open Patent Publication (Kokai) No. 2004-64285).

The equipment disclosed in Japanese Laid-Open Patent Publication (Kokai) No. 2004-64285, when receiving a printing instruction for particular effect, can print a still image having the effect. Further, this equipment can print an image having particular effect which a person desires to show to another person while viewing the moving image, so that it is possible to convey content corresponding to a digest using a printed matter of a still image instead of showing the moving image.

Further, there is an album creating method for determining layout of an album such as a photo book using characteristics of an image and image information (see Japanese Laid-Open Patent Publication (Kokai) No. 2006-261863).

However, while the equipment disclosed in Japanese Laid-Open Patent Publication (Kokai) No. 2004-64285, can extract a still image having particular effect designated in the moving image, the user cannot immediately understand what kind of meaning the extracted still image has in the moving image.

Therefore, when a still image extracted from the moving image is printed, the still image is printed while the user does not know what kind of meaning the effect which is targeted has in the moving image. As a result, even if an album is edited by collecting printed matters created from still images extracted from the moving image, there is a possibility that the album may express content different from the original moving image.

The present invention provides an image processing apparatus and a print control apparatus which allows a user to easily understand content expressed in a moving image of a print source when a still image extracted from the moving image is printed, and a control method and a control program thereof.

### SUMMARY OF THE INVENTION

According a first aspect of the present invention, an image processing apparatus comprises a designating unit configured to designate a moving image as a print target, an image specifying unit configured to specify a material image to be printed based on composition information associated with the moving image designated as the print target by the designating unit, the composition information including information for specifying a plurality of original images used for generating the moving image, and a transmitting unit configured to transmit the material image specified by the image specifying unit and the composition information to a print control apparatus to instruct the print control apparatus to perform printing.

According a second aspect of the present invention, a print control apparatus comprises a storage unit configured to store composition information including information for specifying a type of effect applied when a moving image is generated and a material image to be printed, a layout determining unit configured to determine layout of a page of a printed matter according to the information for specifying the type of effect included in the composition information, and a print data generating unit configured to generate print data by arranging the material image based on the layout of the page.

According a third aspect of the present invention, a control method of an image processing apparatus comprises a designating step of designating a moving image as a print target, an image specifying step of specifying a material image to be printed based on composition information associated with the moving image designated as the print target in the designating step, the composition information including information for specifying a plurality of original images used for generating the moving image, and a transmitting step of transmitting the material image specified in the image specifying step and the composition information to a print control apparatus to instruct the print control apparatus to perform printing.

According a fourth aspect of the present invention, a control method of a print control apparatus, comprises a storage step of storing composition information including information for specifying a type of effect applied when a moving image is generated and a material image to be printed in a memory, a layout determining step of determining layout of a page of a printed matter according to the information for specifying the type of effect included in the composition information, and a print data generating step of generating print data by arranging the material image based on the layout of the page.

According a fifth aspect of the present invention, a computer-readable non-transitory storage medium is for storing a program for causing a computer to execute a control method of an image processing apparatus. The control method comprises a designating step of designating a moving image as a print target, an image specifying step of specifying a material image to be printed based on composition information associated with the moving image designated as the print target in the designating step, the composition information including information for specifying a plurality of original images used for generating the moving image, and a transmitting step of transmitting the material image specified in the image specifying step and the composition information to a print control apparatus to instruct the print control apparatus to perform printing.

According a sixth aspect of the present invention, a computer-readable non-transitory storage medium is for storing a program for causing a computer to execute a control method of a print control apparatus. The control method comprises a storage step of storing composition information including information for specifying a type of effect applied when a moving image is generated and a material image to be printed in a memory, a layout determining step of determining layout of a page of a printed matter according to the information for specifying the type of effect included in the composition information, and a print data generating step of generating print data by arranging the material image based on the layout of the page.

Further features of the present invention will become apparent from the following description of exemplary embodiments (with reference to the attached drawings).

According to the present invention, images used in a moving image to be printed are specified as material images according to composition information, and the material images and the composition information are transmitted to a print control apparatus. By this means, it is possible to easily recognize content expressed in the moving image of a print source from images obtained through printing also when the moving image is printed.

### BRIEF DESCRIPTION OF THE DRAWINGS

FIG. 1 is a block diagram showing an example of a moving image printing system in which an image pickup apparatus and a print control apparatus according to an embodiment of the present invention are used.

FIG. 2 is a diagram showing an example of image data recorded in an SD card in a camera shown in FIG. 1.

FIG. 3 is a flowchart for explaining editing of a moving image performed in the camera shown in FIG. 1.

FIG. 4A is a diagram showing a screen which allows a user to designate creation conditions used when an edited moving image is created at the camera shown in FIG. 1.

FIG. 4B is a diagram showing a screen which allows a user to designate a period used when the edited moving image is created at the camera shown in FIG. 1.

FIG. 5 is a diagram showing an example of a list of images generated at a CPU shown in FIG. 1.

FIGS. 6A and 6B are flowcharts for explaining an example of generation of composition information shown in FIG. 3.

FIG. 7 is a diagram for explaining processing for determining a material image used for flash effect (highlight) shown in FIGS. 6A and 6B.

FIG. 8 is a diagram showing an example of a list of images for highlight generated through highlight determination processing shown in FIG. 7.

FIGS. 9A and 9B are diagrams showing an example of a composition information table generated at the camera shown in FIG. 1.

FIG. 10 is a diagram showing an example of a reproduction period determination table used at the camera shown in FIG. 1.

FIG. 11 is a diagram showing an example of a size table which specifies a size of an edited moving image generated at the camera shown in FIG. 1.

FIG. 12A to FIG. 12C are diagrams showing images of material images scroll displayed at the camera shown in FIG. 1.

FIG. 12D to FIG. 12G are diagrams showing rectangles defining display regions.

FIG. 13A is a diagram showing coordinates of the display region shown in FIG. 12G.

FIG. 13B is a diagram showing change of coordinates when an image is scroll displayed.

FIG. 14 is a diagram showing an example of a recording destination of a composition information file generated at the camera shown in FIG. 1.

FIG. 15A is a diagram showing an edited moving image, a print button and a return button displayed at the camera shown in FIG. 1.

FIG. 15B is a diagram showing an edited moving image and a return button displayed at the camera shown in FIG. 1.

FIG. 15C is a diagram showing an example of a screen displayed at a display when the print button shown in FIG. 15A is manipulated.

FIG. 16 is a flowchart for explaining confirmation processing of confirming a function of a server PC performed at the camera shown in FIG. 1.

FIG. 17 is a diagram for explaining the confirmation processing of a printing function of the server PC shown in FIG. 16.

FIG. 18 is a diagram for explaining confirmation processing of a minimum required image size at the server PC shown in FIG. 16.

FIG. 19 is a flowchart for explaining an example of printing processing procedure performed at the camera shown in FIG. 1.

FIG. 20 is a flowchart for explaining printing processing performed at the server PC shown in FIG. 1.

FIGS. 21A and 21B are diagrams showing a composition information file for transmission received at the server PC shown in FIG. 1.

FIG. 22 is a diagram showing an example of registration destinations of the composition information file for transmission, images for printing and email addresses received at the server PC shown in FIG. 1.

FIG. 23 is a diagram for explaining an example of print layout determination processing shown in FIG. 20.

FIG. 24 is a diagram showing a structure of an example of a print layout definition file shown in FIG. 22.

FIG. 25A is a diagram showing front page layout which is a result of print layout processing performed at the server PC shown in FIG. 1.

FIG. 25B is a diagram showing title effect layout which is a result of the print layout processing performed at the server PC shown in FIG. 1.

FIG. 25C is a diagram showing still image effect layout and moving image effect layout which are results of the print layout processing performed at the server PC shown in FIG. 1.

FIG. 25D is a diagram showing continuous shooting effect layout which is a result of the print layout processing performed at the server PC shown in FIG. 1.

FIG. 25E is a diagram showing cameraman introduction effect layout which is a result of the print layout processing performed at the server PC shown in FIG. 1.

FIG. 25F is a diagram showing highlight display effect layout which is a result of the print layout processing performed at the server PC shown in FIG. 1.

FIG. 26A is a diagram showing an example of a print preview confirmation screen which can be viewed through the camera shown in FIG. 1.

FIG. 26B is a diagram showing an example of an editing screen which can be viewed through the camera shown in FIG. 1.

FIG. 26C is a diagram showing an example of a layout switching screen which can be viewed through the camera shown in FIG. 1.

FIG. 27 is a flowchart for explaining an example of image arrangement processing using an effect of the combination of a still image and a moving image, which is performed at the server PC shown in FIG. 1.

FIG. 28 is a diagram showing distribution of images to be used in the image arrangement processing shown in FIG. 27.

FIG. 29 is a flowchart for explaining layout determination processing shown in FIG. 27.

FIG. 30 shows Table 1 indicating layout selected by the CPU illustrated in FIG. 1.

FIG. 31A to FIG. 31D are diagrams showing examples of types of layout determined in the layout determination processing shown in FIG. 29.

FIG. 32A to FIG. 32C are diagrams showing arrangement of images according to layout determined through the layout determination processing shown in FIG. 29.

FIG. 33 is a flowchart for explaining another example of the image arrangement processing performed at the server PC shown in FIG. 1.

FIG. 34 is a flowchart for explaining the layout determination processing shown in FIG. 33.

FIG. 35 shows Table 2 for explaining types of layout selected by the CPU illustrated in FIG. 1.

FIG. 36A to FIG. 36D are diagrams showing examples of types of layout determined through the layout determination processing shown in FIG. 34.

FIG. 37A and FIG. 37B are diagrams showing arrangement of images according to layout determined through the layout determination processing shown in FIG. 34.

FIG. 38 is a flowchart for explaining still another example of the image arrangement processing performed at the server PC shown in FIG. 1.

FIG. 39 is a flowchart for explaining the layout determination processing shown in FIG. 38.

FIG. 40 shows Table 3 for explaining types of layout selected by the CPU illustrated in FIG. 1.

FIG. 41A and FIG. 41B are diagrams showing arrangement of images according to layout determined through the layout determination processing shown in FIG. 37.

### DESCRIPTION OF THE EMBODIMENTS

The present invention will now be described in detail below with reference to the accompanying drawings showing embodiments thereof.

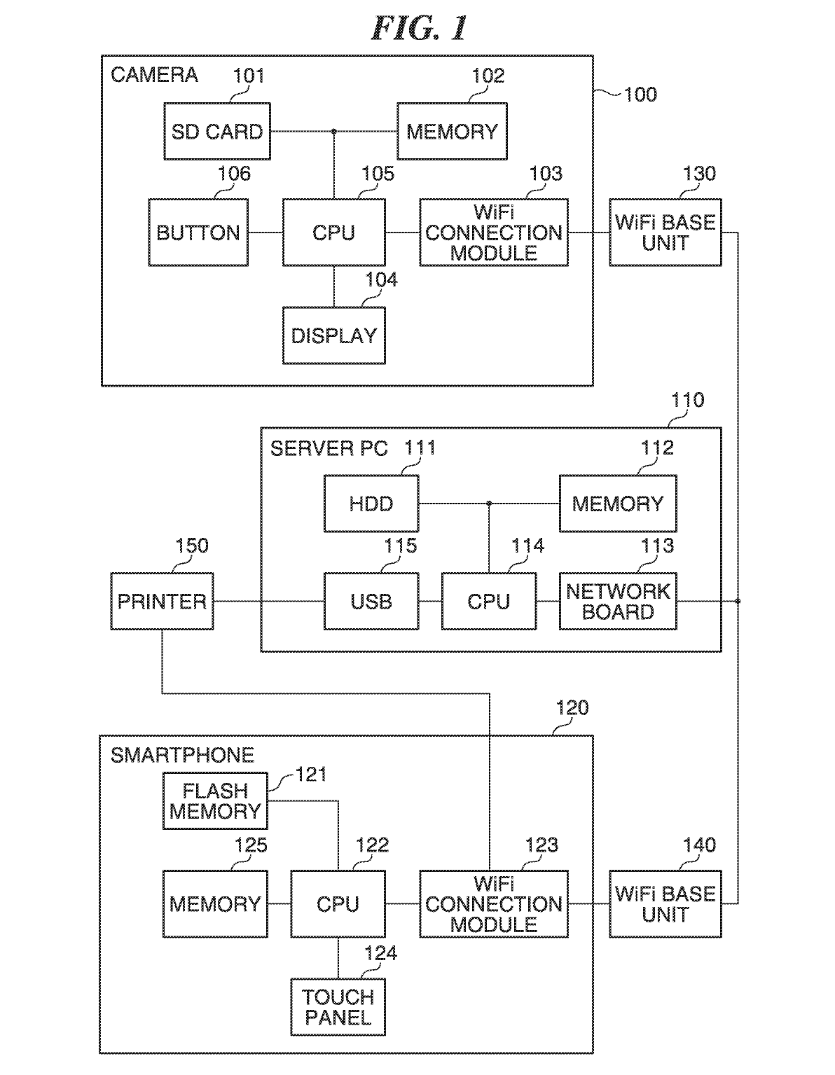

FIG. 1 is a block diagram showing an example of a moving image printing system in which an image pickup apparatus and a print control apparatus according to an embodiment of the present invention are used.

The moving image printing system shown in the figure has at least an image pickup apparatus 100 and a server PC 110 which is one of print control apparatuses. The image pickup apparatus 100 is, for example, a digital camera (hereinafter, simply referred to as a camera), and the moving image printing system may include a terminal apparatus such as a smartphone 120.

The camera 100 has a CPU 105 which controls the camera 100. In an SD card 101 which is a recording medium, an image (shot image) obtained as a result of shooting by an image pickup unit (not shown) and an image (camera created image) generated through editing, or the like, at the camera 100 are recorded. In a memory 102, a program to be executed by the CPU 105 is recorded.

Further, the camera 100 includes a WiFi connection module 103 used as a communication unit, and a display 104. At the display 104, the shot image and the camera created image are displayed, and a user interface screen (UI screen) is displayed. A user manipulates the UI screen using a button 106.

The CPU 105 executes the program stored in the memory 102 to control the camera 100. In the memory 102, a program required to operate the CPU 105 is recorded. Further, the memory 102 is used as a work memory of the CPU 105. The CPU 105 controls the WiFi connection module 103 to perform communication with the server PC 110 via a WiFi base unit 130.

The server PC 110 includes a CPU 114, a network board 113, a memory 112, an HDD 111 and a USB terminal 115. The CPU 114 executes a program recorded in the HDD 111 to control the server PC 110. Further, the HDD 111 is used as a memory unit in which a layout definition file which will be described later is stored. The memory 112 is used as a work memory required to operate the CPU 114. The CPU 114 controls the network board 113 to perform communication with the camera 100 via a network (for example, Internet).

As shown in the figure, a printer 150 is connected to the server PC 110 via the USB terminal 115. As will be described later, the server PC 110 creates print data and causes the printer 150 to perform printing according to the print data.

In an example of the figure, the smartphone 120 can be a substitute for the camera 100 or a substitute for the server PC 110. The smartphone 120 includes a CPU 122, a flash memory 121, a memory 125, a touch panel 124 and a WiFi connection module 123.

The CPU 122 executes a program recorded in the flash memory 121 to control the smartphone 120. The memory 125 is used as a work memory required to operate the CPU 122. The CPU 122 controls the WiFi connection module 123 to perform communication with the server PC 110 through a WiFi base unit 140.

Further, the CPU 122 can wirelessly connect to the printer 150 via the WiFi connection module 123. The CPU 122 transmits print data to the printer 150 through the WiFi connection module 123 to perform printing according to the print data.

As illustrated in the figure, a display unit (not shown) including the touch panel 124 is connected to the CPU 122, and a result according to the processing by the CPU 122 is displayed at the display unit. The user transmits various instructions to the CPU 122 through touch operation using the touch panel 124.

Because the moving image printing system only has to have at least the camera 100 and the server PC 110, a case where the moving image printing system includes the camera 100 and the server PC 110 will be described first.

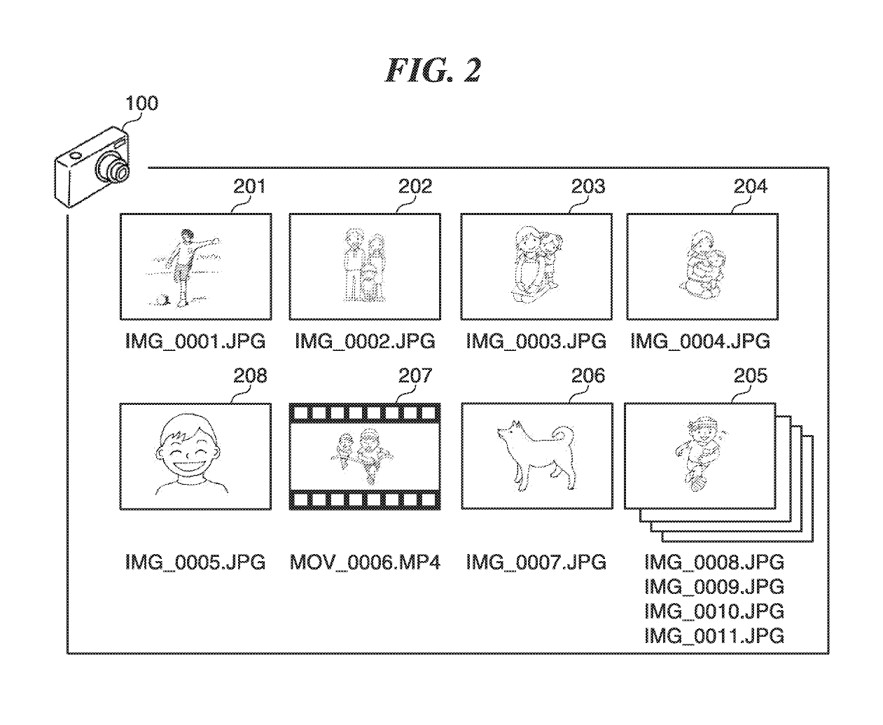

FIG. 2 is a diagram showing an example of image data recorded in the SD card 101 in the camera 100 shown in FIG. 1.

In the SD card 101, still images 201 to 204, 206 and 208 and a moving image 207 and a still image group 205 obtained through continuous shooting are recorded as image data. New moving image data (hereinafter, referred to as an edited moving image) is created using the image data recorded in the SD card 101.

In the image data, for example, a file name, date and time of shooting, a format, a subject name (in the case of a person) and a rating are recorded.

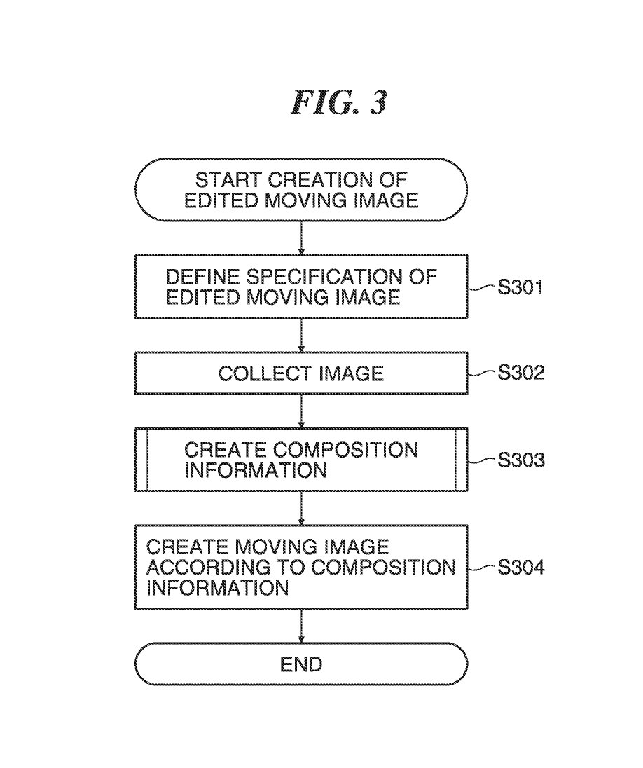

FIG. 3 is a flowchart for explaining editing of a moving image performed at the camera 100 shown in FIG. 1.

When editing of a moving image (that is, creation of a moving image to be printed) is started, the CPU 105 first defines specification of a moving image to be edited (step S301).

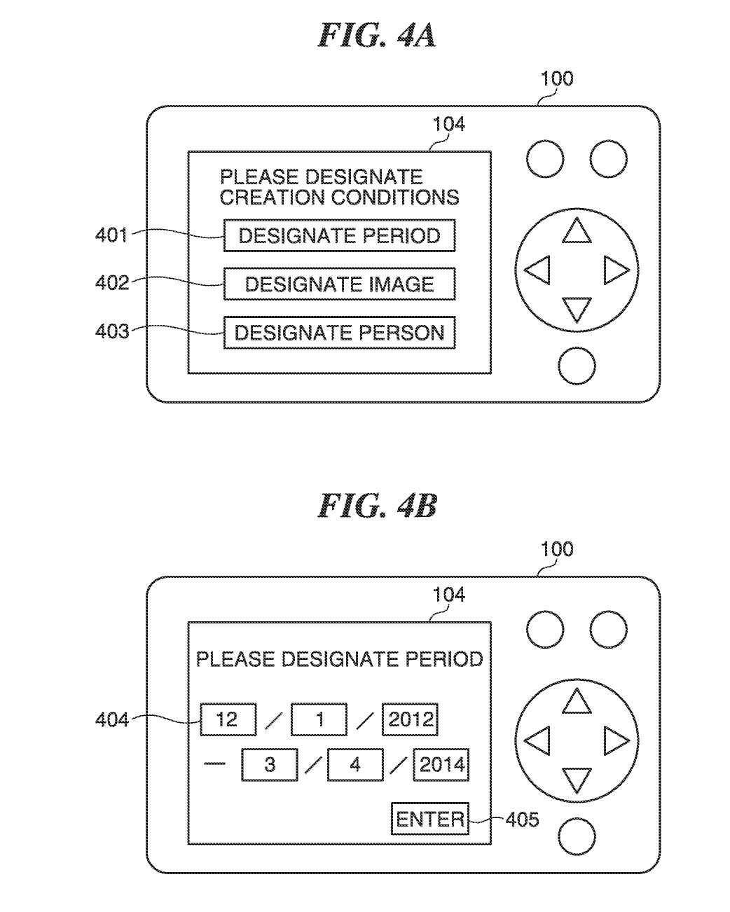

FIG. 4A is a diagram showing a screen for allowing the user to designate creation conditions used when an edited moving image is created at the camera shown in FIG. 1.

When definition of the specification of the edited moving image is started, the CPU 105 displays a creation condition designation screen shown in FIG. 4A at the display 104. The user designates a kind of the edited moving image to be created using the creation condition designation screen.

In the example shown in FIG. 4A, three option buttons are displayed on the creation condition designation screen. An option button 401 is a button for limiting a shooting period to a specific period and creating an edited moving image using image data shot during the period.

An option button 402 is a button for individually designating image data to be used for the edited moving image. Further, an option button 403 is a button for designating a subject (here, a person) and creating an edited moving image which focuses on the subject.

In the following description, processing when the option button 401 is manipulated by the user will be described.

FIG. 4B is a diagram showing a screen for allowing the user to designate a period to be used when an edited moving image is created with the camera shown in FIG. 1.

When the option button 401 is pressed, the CPU 105 displays a period designation screen 404 shown in FIG. 4B at the display 104. The user inputs a shooting period on the period designation screen 404.

It is assumed here that the user designates “from Dec. 1, 2012 to Mar. 4, 2014” as the shooting period. When the user presses an enter button 405, the CPU 105 settles the shooting period as the specification of a moving image to be created.

Referring to FIG. 3 again, the CPU 105 collects image data according to the specification of the moving image to be created, here, according to the shooting period (step S302). That is, the CPU 105 generates a list of images by collecting image data from the SD card 101 according to the designated shooting period.

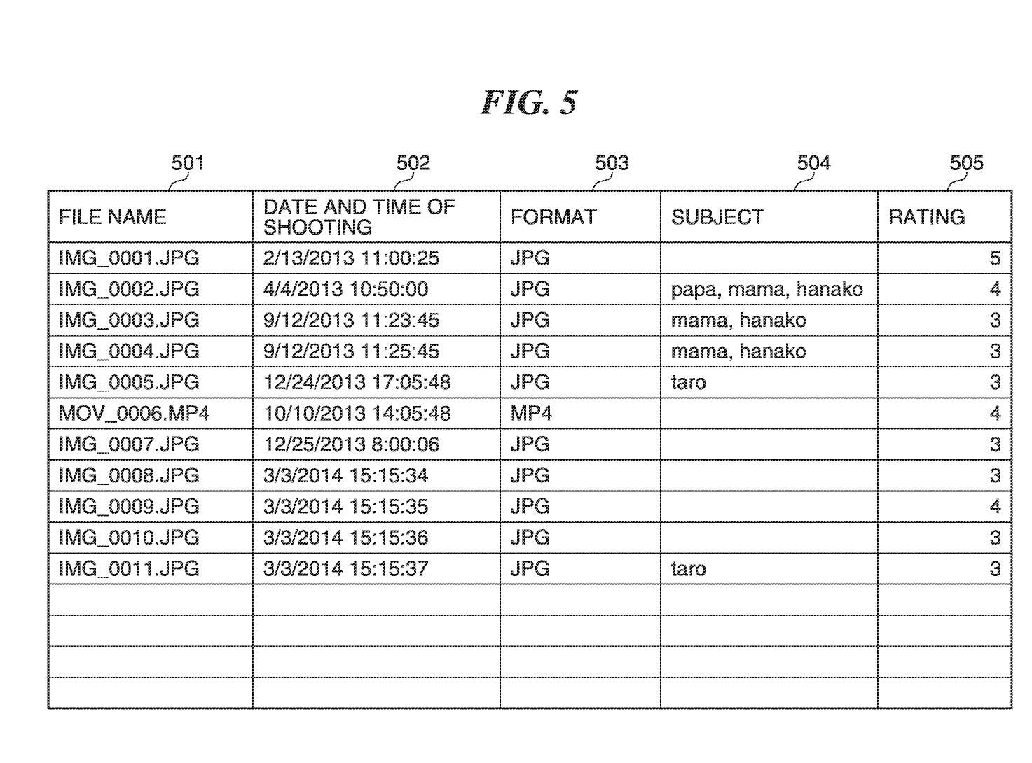

FIG. 5 is a diagram showing an example of the list of images generated by the CPU 105 shown in FIG. 1.

The CPU 105 generates a list of images indicating attribute information (also referred to as image information) of the images recorded in the SD card 101 according to the shooting period. The list of images include five items: a file name 501, date and time of shooting 502, a format 503, a subject (subject name) 504 and a rating 505. While the list of images include five items here, the number of items may be increased or decreased according to an edited moving image.

In the file name 501, a file name of the image data in the SD card 101 is described. In the date and time of shooting 502, date and time at which the image data is shot is described. In the format 503, a format name of the image data is described. In the subject 504, a subject name (person name) present in the image data is described. When there are a plurality of subjects in the image data, all subject names relating to the plurality of subjects are described. In the rating 505, a rating indicating how much the user likes the image data is described.

It should be noted that concerning the subject name, subject information (subject name) is recorded in advance in association with image data, and the CPU 105 loads the subject information when generating a list of images. It is also possible to allow the user to input a subject name while viewing an image. Further, the rating 405 is evaluated, for example, from “1” to “5”, and the user sets the rating in advance for each image data.

As described above, because from Dec. 1, 2012 to Mar. 4, 2014 is designated as the shooting period, the CPU 105 searches for the image data whose date and time of shooting falls within the shooting period to generate a list of images. After collecting the images, the CPU 105 creates composition information indicating composition of the edited moving image (step S303). This composition image includes information for specifying original images.

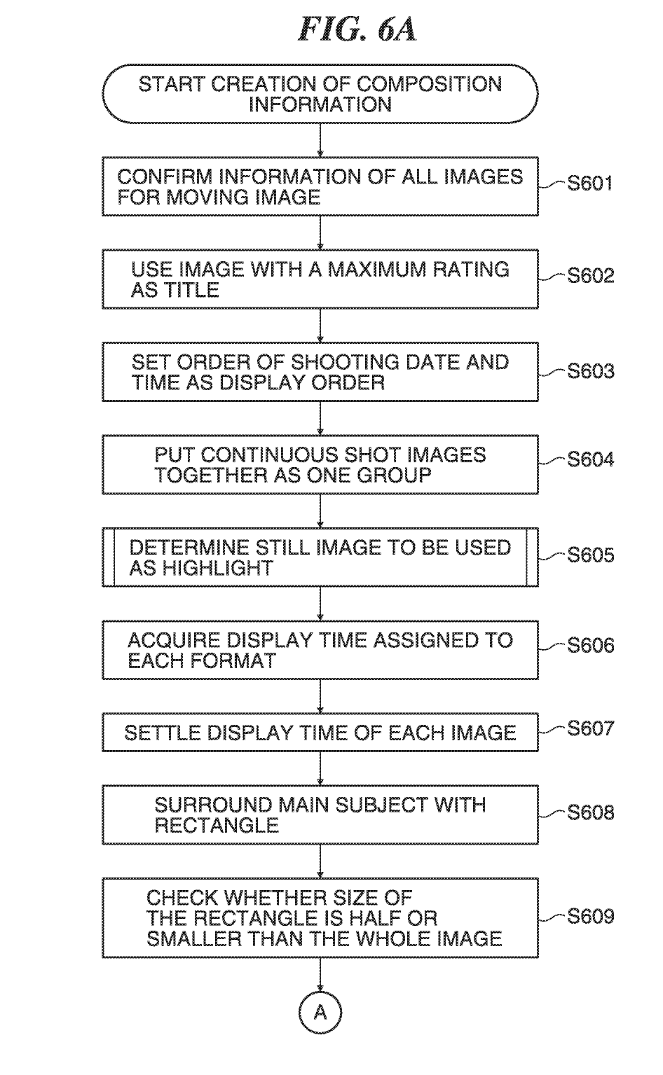

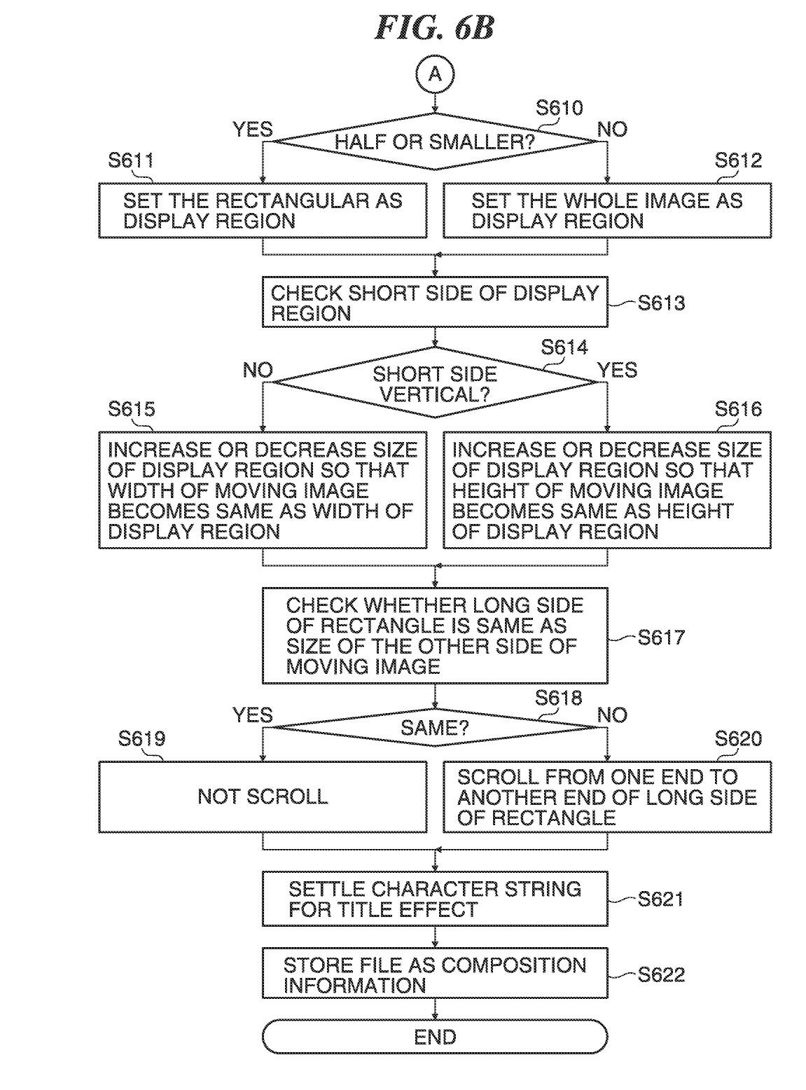

FIGS. 6A and 6B are flowcharts for explaining generation of the composition information shown in FIG. 3.

When generation of the composition information is started, the CPU 105 confirms the image information regarding the image data (that is, material images) relating to the edited moving image using the list of images (step S601). Then, the CPU 105 determines a material image to be used as a title effect of the edited moving image. Here, the CPU 105 determines a material image with the highest rating as the material image to be used as the title effect (step S602).

In the example shown in FIG. 5, a material image having the file name 501 of IMG_0001.JPG has the highest rating 505. Therefore, the CPU 105 determines the material image having the file name 501 of IMG_0001.JPG as the material image used as the title effect.

Subsequently, the CPU 105 determines a display order of material images in the edited moving image. Here, for example, the CPU 105 determines to display the material images according to the date and time of shooting of the list of images (step S603).

Then, the CPU 105 performs processing of putting continuous shot images generated through one shooting together as one group (step S604). Here, the CPU 105 performs processing of putting the continuous shot images together as one group with reference to the date and time of shooting 502 of the list of images while assuming that the continuous shot images are, for example, still images reproduced at intervals of one second. In the example shown in FIG. 5, the file name of IMG_0008.JPG, IMG_0009.JPG, IMG_0010.JPG and IMG_0011.JPG are continuous shot images.

It should be noted that if continuous shot image information indicating that images are continuous shot images is added to the image data upon continuous shooting, the CPU 105 may determine whether or not the image data is continuous shot images according to the continuous shot image information.

Subsequently, as will be described later, the CPU 105 determines material images to be used for flash effect (highlight) from still images (step S605). Here, the flash effect is effect used at opening of the moving image, and effect for allowing the user to recognize content of the edited moving image at the opening through display of still images used in the edited moving image being switched at short intervals.

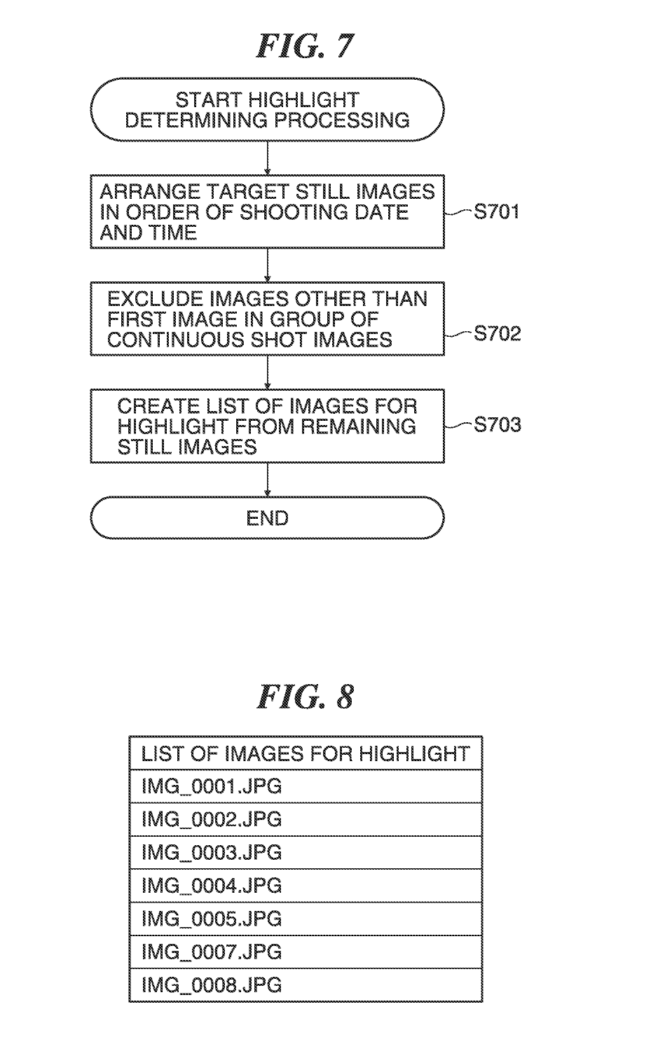

FIG. 7 is a diagram for explaining processing of determining the material images used for the flash effect (highlight) shown in FIGS. 6A and 6B (highlight determination processing).

When the highlight determination processing is started, the CPU 105 arranges still images in order of date and time of shooting to determine material images for highlight (for flash effect) (step S701). Then, the CPU 105 excludes still images other than a top image in a series of continuous shot images (step S702). The CPU 105 then creates a list of images for flash effect (for highlight) from the remaining still images (step S703) and finishes the highlight determination processing.

FIG. 8 is a diagram showing an example of the list of images for highlight generated through the highlight determination processing shown in FIG. 7.

In FIG. 8, in the list of images for highlight, the file name of IMG_0001.JPG, IMG_0002.JPG, IMG_0003.JPG, IMG_0004.JPG, IMG_0005.JPG, IMG_0007.JPG and IMG_0008.JPG are determined as images for highlight in order of date and time of shooting.

The edited moving image starts from the material image used as the title effect, and, after the material images used as the flash effect are displayed, the body is displayed. Therefore, the CPU 105 generates a composition information table indicating what kind of effect is used to display each material image in the edited moving image.

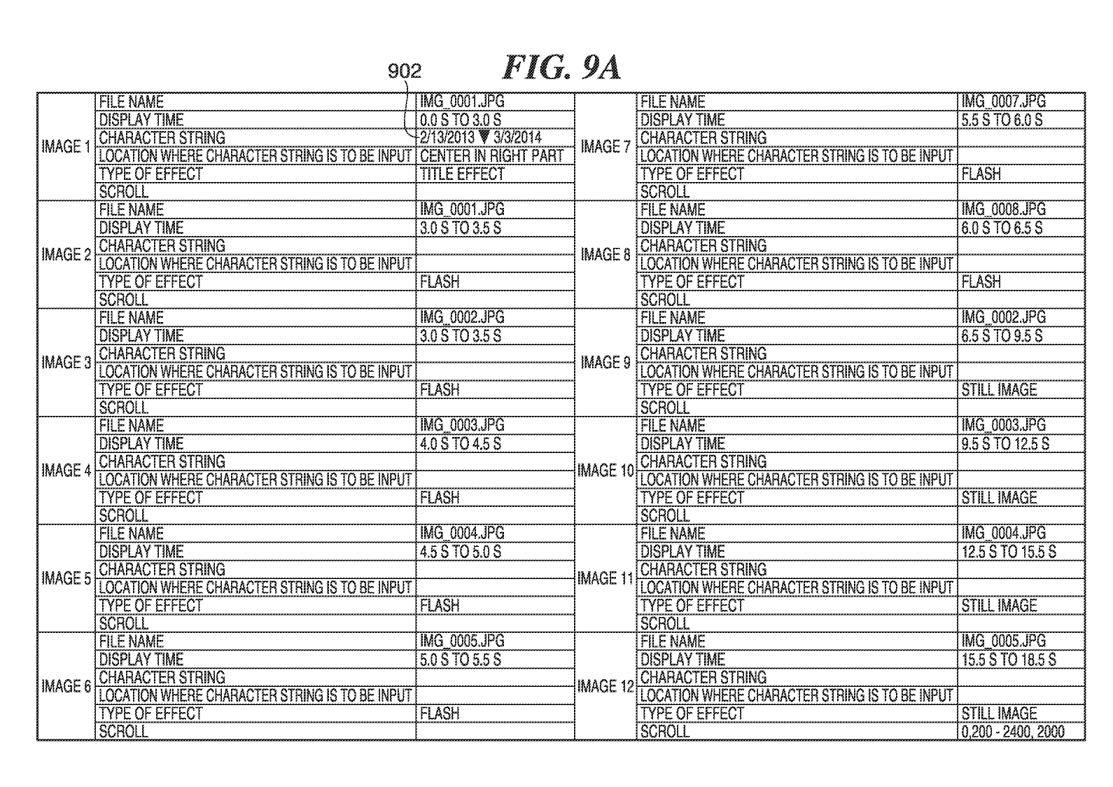

FIGS. 9A and 9B are diagrams showing an example of the composition information table generated at the camera 100 shown in FIG. 1. It should be noted that, in the example shown in the figure, the material images include image 1 to image 22.

In the composition information table (also referred to as a composition information file) shown in the figure, material images used as part of the edited moving image are listed. Effect, a display period and character information relating to a displayed character string in the edited moving image are described for each material image.

For example, a file name, a display period, a displayed character string (hereinafter, simply referred to as a character string), location where a character string is to be input, a type of effect and scroll are described for each material image. In the file name, a file name of a material image in the SD card 101 is described. In the display period, a reproduction period in the edited moving image according to the format of the material image and the effect is described.

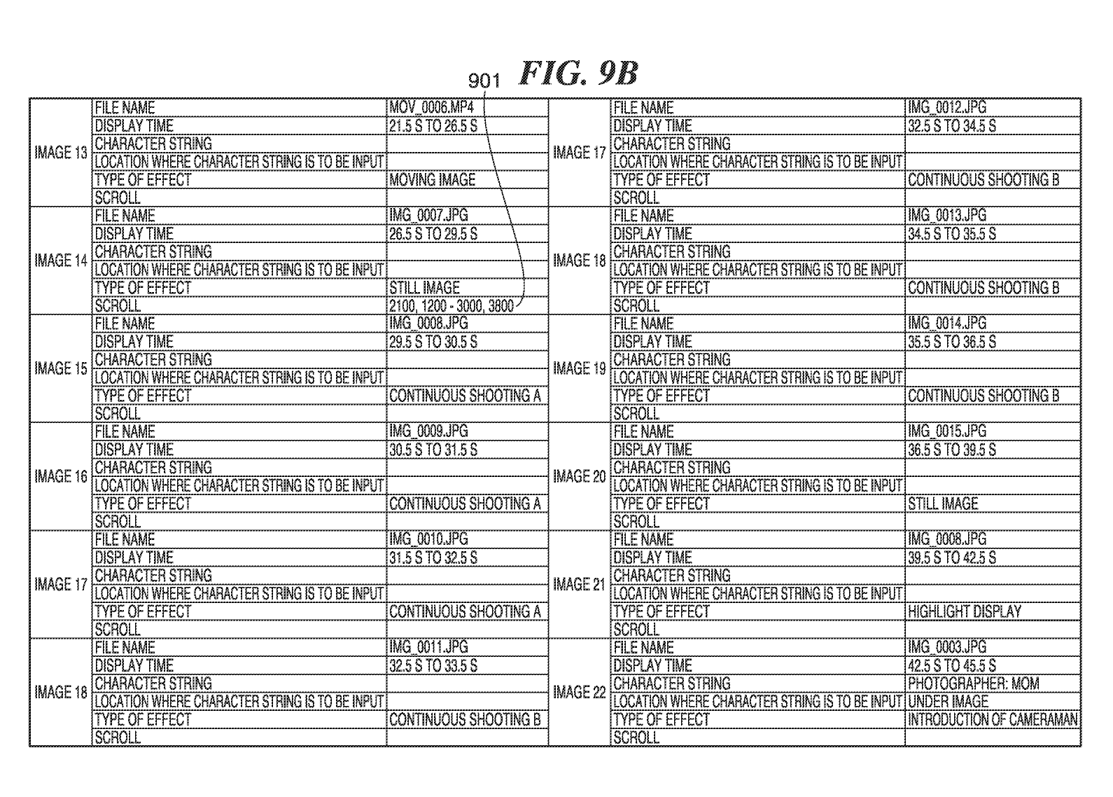

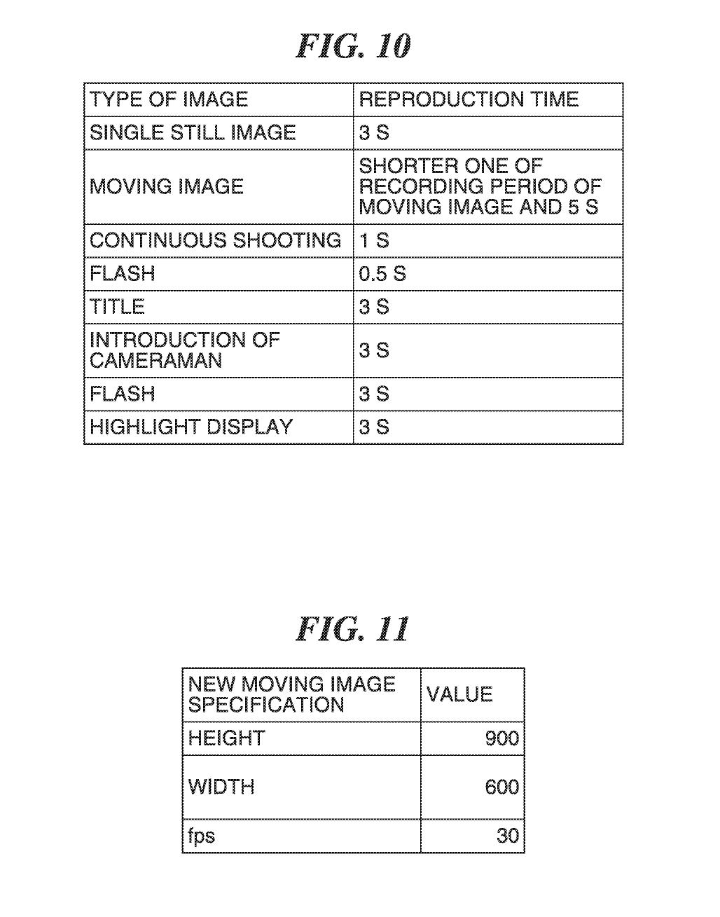

FIG. 10 is a diagram showing an example of a reproduction period determination table used in the camera 100 shown in FIG. 1. It should be noted that the reproduction period determination table shown in the figure is stored in advance in, for example, the memory 102 shown in FIG. 1.

The CPU 105 determines a reproduction period for each material image according to, for example, a format with reference to the reproduction period determination table. In the reproduction period determination table shown in FIG. 10, a single still image, a moving image, continuous shooting, flash, title, introduction of a cameraman (introduction of a photographer), and highlight display are defined as types of the material image, and the reproduction period is defined according to these types.

Referring to FIGS. 9A and 9B again, in the character string and the location where the character string is to be input, a character string to be displayed when the material image is displayed in the edited moving image and location where the character string is displayed in the edited moving image are respectively designated. In the types of effect, a name of special effect applied when the material image is edited to the moving image is described. In the scroll, if the material image displayed in the edited moving image is not the whole image but part of the image, a coordinate indicating the part is designated.

It should be noted that, even when the same effect is applied for the edited moving image, if there is large difference in a shooting period or a shooting target between material images, effect information is described using expression indicating that the images belong to different groups though the effect is the same.

Referring to FIGS. 6A and 6B again, after determining the material image for highlight is determined, the CPU 105 confirms a display period assigned to the type of images (step S606). As described above, the reproduction period determination table shown in FIG. 10 in which the reproduction period is defined for each type of image is stored in the memory 102.

The CPU 105 settles the display period during which a material image used for effect in the edited moving image is displayed according to the reproduction period table for each type of images (step S607). The CPU 105 then assigns the reproduction period for each type of images, that is, the display period to the material images in the composition information table shown in FIGS. 9A and 9B and determines effect switching time in the edited moving image.

Subsequently, the CPU 105 performs processing of surrounding a main subject present in the material image with a rectangle (S608). Here, when surrounding the main subject with the rectangle, the CPU 105 sets an object (for example, a person) having a maximum size present in the material image as the main subject. It should be noted that the user may designate the main subject with reference to the material image displayed at the display 104.

The CPU 105 then checks whether or not the size of the rectangle is equal to or smaller than half of the size of the material image (that is, the whole image) (step S609). The CPU 105 then determines whether or not the size of the rectangle is equal to or smaller than the half of the size of the material image (step S610).

If the size of the rectangle is equal to or smaller than the half of the size of the material image (step S610: Yes), the CPU 105 sets only a region indicated with part of the rectangle in the material image as a display region to be displayed in the edited moving image (step S611). Meanwhile, if the size of the rectangle exceeds the half of the size of the material image (step S610: No), the CPU 105 sets the whole material image as a display region in the edited moving image (step S612).

After the processing of step S611 or S612, the CPU 105 checks whether a short side of the display region is a longitudinal direction or a lateral direction (step S613). The CPU 105 then determines whether or not the short side of the display region is a longitudinal direction, that is, whether or not the display region is horizontally long (step S614).

If the display region is vertically long (step S614: No), the CPU 105 increase or decreases the size of the display region so that the width of the edited moving image is the same as the width of the display region (step S615). Meanwhile, if the display region is horizontally long (step S614: Yes), the CPU 105 increases or decreases the size of the display region so that the height of the edited moving image is the same as the height of the display region (step S616).

FIG. 11 is a diagram showing an example of a size table in which the size of the edited moving image generated at the camera 100 shown in FIG. 1 is defined. The size table shown in the figure is stored in, for example, the memory 102, and the CPU 105 acquires the size of the edited moving image from the size table shown in FIG. 11 in the processing of step S615 and step S616.

After the processing of step S615 or step S616, the CPU 105 checks whether or not the length of the long side of the display region is the same as the length of the corresponding side in the edited moving image when increasing or decreasing the size of the display region (step S617). That is, the CPU 105 checks whether or not a ratio of the height and the width of the display region is the same as a ratio of the height and the width of the edited moving image. The CPU 105 then determines whether or not the ratio of the height and the width of the display region is the same as the ratio of the height and the width of the edited moving image (step S618).

If the ratio of the height and the width of the display region is the same as the ratio of the height and the width of the edited moving image (step S618: Yes), the CPU 105 determines not to scroll display the display region in the edited moving image (step S619). Meanwhile, if the ratio of the height and the width of the display region is not the same as the ratio of the height and the width of the edited moving image (step S618: No), the CPU 105 determines to scroll display the display region from one end to the other end of the long side so that the whole display region can be displayed in the edited moving image (step S620).

It should be noted that, if only a specific region of the material image is displayed regardless of whether or not to perform scroll display, the CPU 105 records an upper left coordinate and a lower right coordinate of the rectangle defining the display region in the composition information table as a scroll position 901.

Here, confirmation of the edited moving image with eyes when the material image is scroll displayed at the camera 100 shown in FIG. 1 will be described.

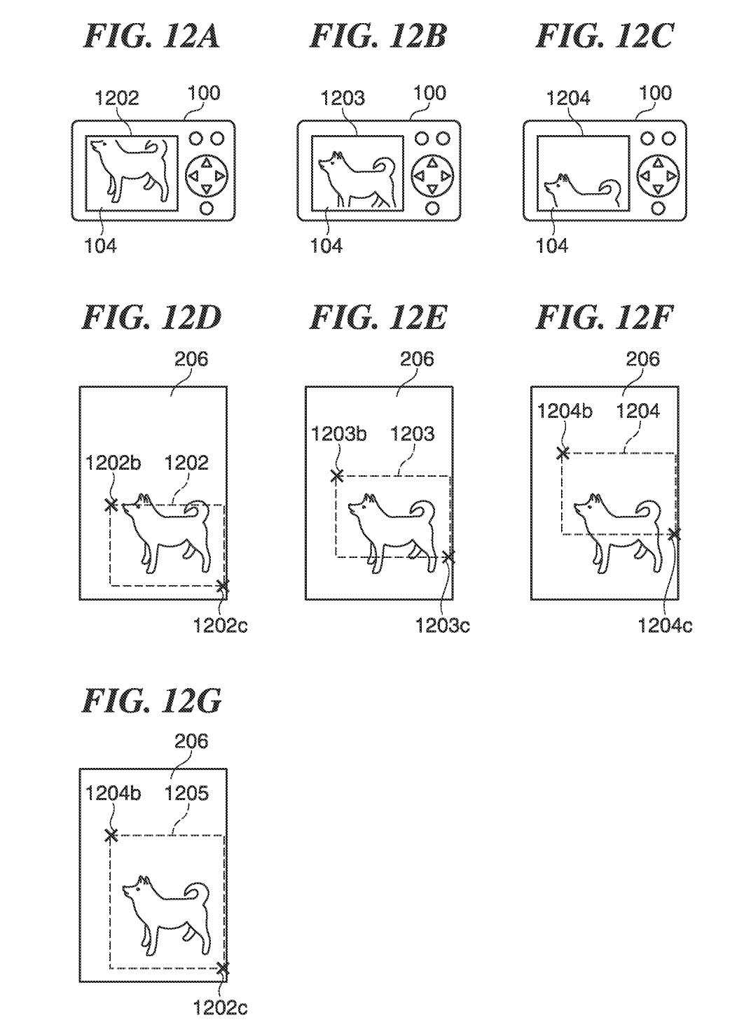

FIG. 12A to FIG. 12C are diagrams showing images in which the material images are scroll displayed at the camera shown in FIG. 1. Further, FIG. 12D to FIG. 12G are diagrams showing rectangles defining display regions.

Now, if scroll display is performed at the camera 100, images, for example, as shown in FIG. 12A to FIG. 12C are displayed at the display 104. Here, a display region 1202, a display region 1203 and a display region 1204 are sequentially displayed at the display 104. That is, in the scroll display, the image does not move, but the display region is sequentially changed to the display region 1202, the display region 1203 and the display region 1204. Now, a display region when scroll display is performed in the processing of the above-described step S620 is shown in FIG. 12G.

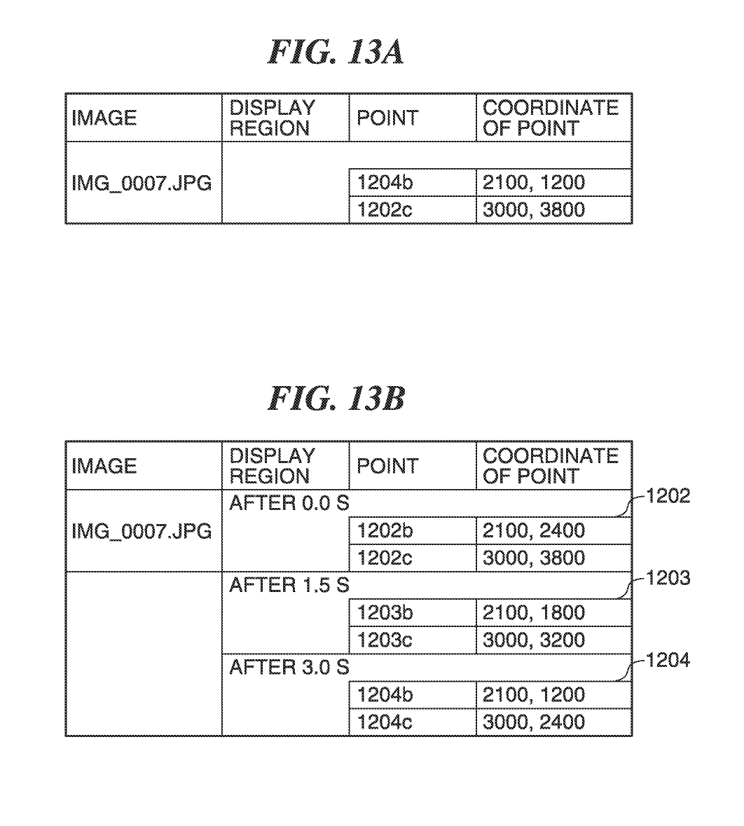

FIG. 13A is a diagram showing a coordinate of the display region shown in FIG. 12G. Further, FIG. 13B is a diagram showing change of the coordinate when scroll display is performed.

The display region 1205 shown in FIG. 12G is a rectangle, and, in the display region 1205, a coordinate of an upper left point 1204b in the material image in the figure is (2100, 1200), and a coordinate of a lower right point 1202c in the material image is (3000, 3800) (see FIG. 13A).

The size of the display region 1205 is vertically large compared to the longitudinal and lateral size of the edited moving image. Therefore, when the display region 1205 is displayed in the edited moving image, the display range is scrolled in a longitudinal direction.

First, a display region 1202a (FIG. 12D) which contacts one of the short side of the display region 1205 and which has the same size as the edited moving image is set as a first display region when the image is scroll displayed. Then, a display region 1204a (FIG. 12F) which contacts the short side opposite from the short side of the display region 1205 contacted by the display region 1202a and which has the same size as the edited moving image is set as a last display region when the image is scroll displayed.

Given the reproduction period indicated in the reproduction period table shown in FIG. 10, the display region 1202a is the scroll displayed material image at a time point of 0.0 second, that is, a display region at the moment display appears, and the display region 1204a is the scroll displayed material image at a time point of 3.0 seconds, that is, a display region at the moment display ends. The display region at a timing of a middle time point of 1.5 seconds is the display region 1203a shown in FIG. 12E.

That is, as shown in FIG. 13B, coordinates (upper left coordinates and lower right coordinates) of the display regions 1202a, 1203a and 1204a change.

Referring to FIGS. 6A and 6B again, after the processing of step S619 or S620, the CPU 105 settles a character string to be used for title effect (step S621). Here, as described above, the button 401 for designating a period is selected in FIG. 4A. Therefore, the CPU 105 uses a shooting period of the material image as the character string to be used for the title effect.

The shooting period of the material image can be confirmed by the date and time of shooting 502 shown in FIG. 5. In the example shown in FIG. 5, the oldest date and time of shooting is “Feb. 13, 2013”, while the latest date and time of shooting is “Mar. 3, 2014”, and, thus, this period becomes the shooting period. The CPU 105 sets the shooting period as a character string 902 for the title effect in the composition information table shown in FIGS. 9A and 9B.

Subsequently, the CPU 105 records the composition information table in the SD card 101 as a composition information file (step S622). The CPU 105 then finishes creation of the composition information and proceeds to processing of step S304 shown in FIG. 3.

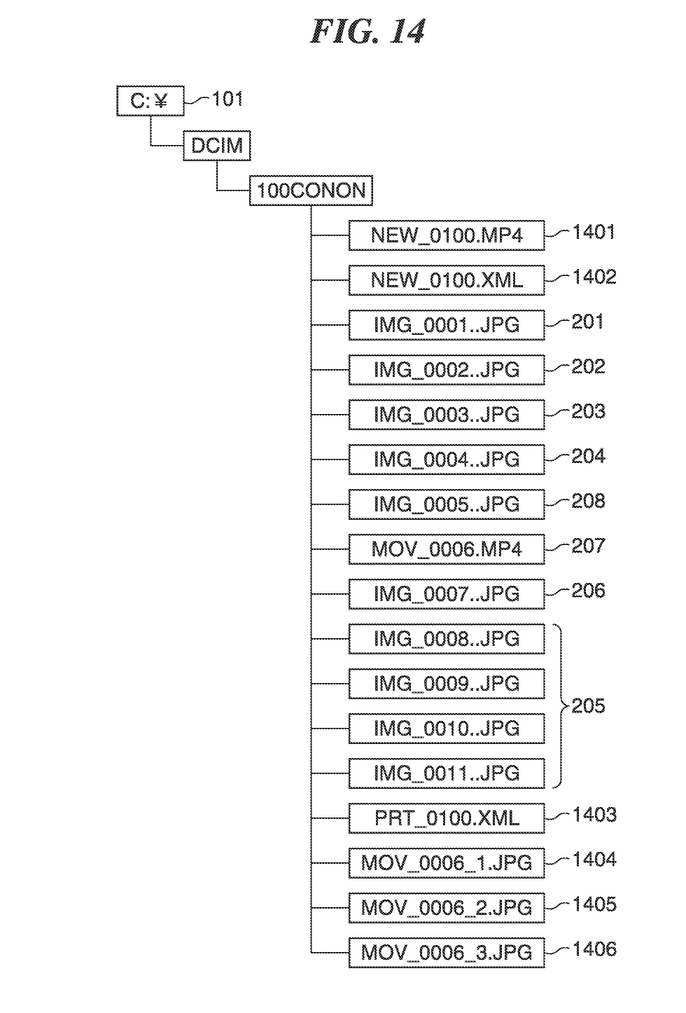

FIG. 14 is a diagram showing an example of a recording destination of the composition information file generated at the camera 100 shown in FIG. 1.

In the SD card 101, the composition information file 1402 is stored with a file name of NEW_0100.XML in a folder formed in a layer which is the same as the layer of the material image.

When the composition information file is recorded in the SD card 101, the CPU 105 finishes creation of the composition information and proceeds to processing of step S304 shown in FIG. 3. In step S304, the CPU 105 generates the edited moving image by collecting material images based on the composition information file 1402.

Upon generating the edited moving image, the CPU 105 confirms a size table (specification of the edited moving image) shown in FIG. 11. The CPU 105 then records the edited moving image as a moving image file 1401 having a file name of NEW_0100.MP4 shown in FIG. 14, which is a file name having the same character string as that of the composition information file 1402 other than an extension, in the same layer as the layer of the composition information file 1402 in the SD card 101. When the generation of the edited moving image is finished, the CPU 105 displays the edited moving image at the display 104.

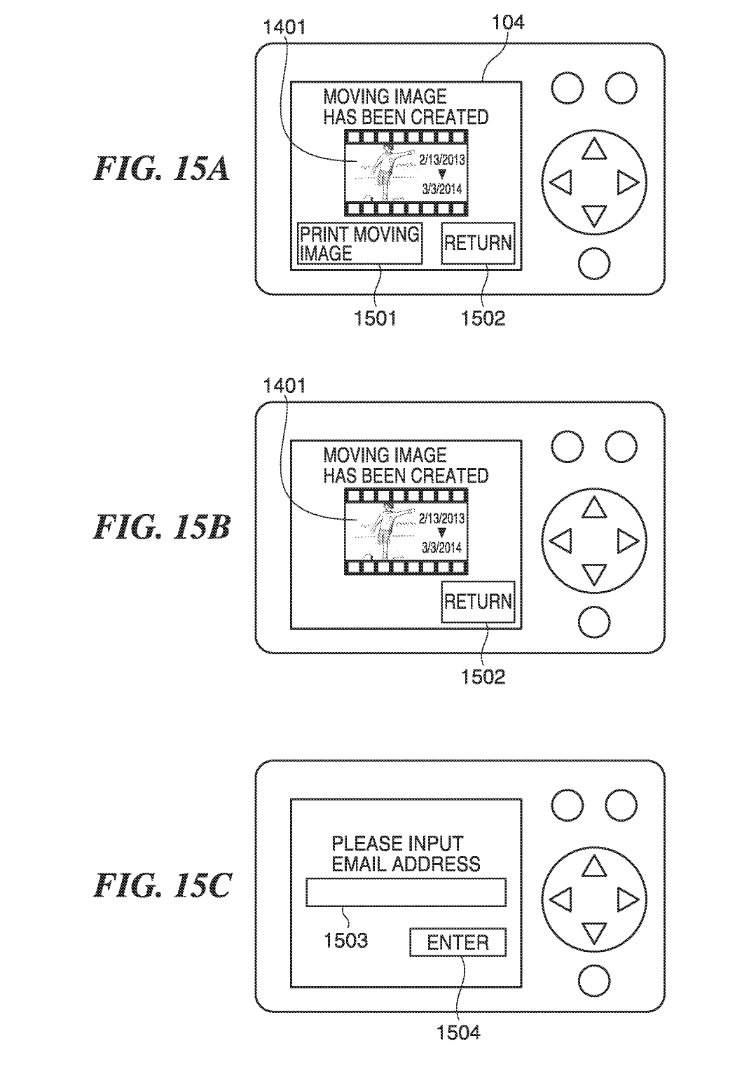

FIG. 15A is a diagram showing the edited moving image, a print button and a return button displayed at the camera shown in FIG. 1. Further, FIG. 15B is a diagram showing the edited moving image and a return button displayed at the camera shown in FIG. 1. Still further, FIG. 15C is a diagram showing an example of a screen displayed at the display when the print button shown in FIG. 15A is manipulated.

As shown in FIG. 15A, the edited moving image according to the moving image file 1401 is displayed at the display 104. Further, a print button 1501 and a return button 1502 are displayed at the display 104 along with the edited moving image. The print button 1501 is used to give an instruction of printing the edited moving image. Further, the return button 1502 is used to shift a state to another state without printing the edited moving image.

When the user presses the print button 1501, the CPU 105 transmits the composition information file 1402 and the material images used for generating the edited moving image to the server PC 110 using the WiFi connection module 103. It should be noted that before the edited moving image is displayed at the display 104, the CPU 105 confirms whether or not the server PC 110 which coordinates with the camera 100 supports printing using the composition information file. That is, the CPU 105 confirms a function of the server PC 110.

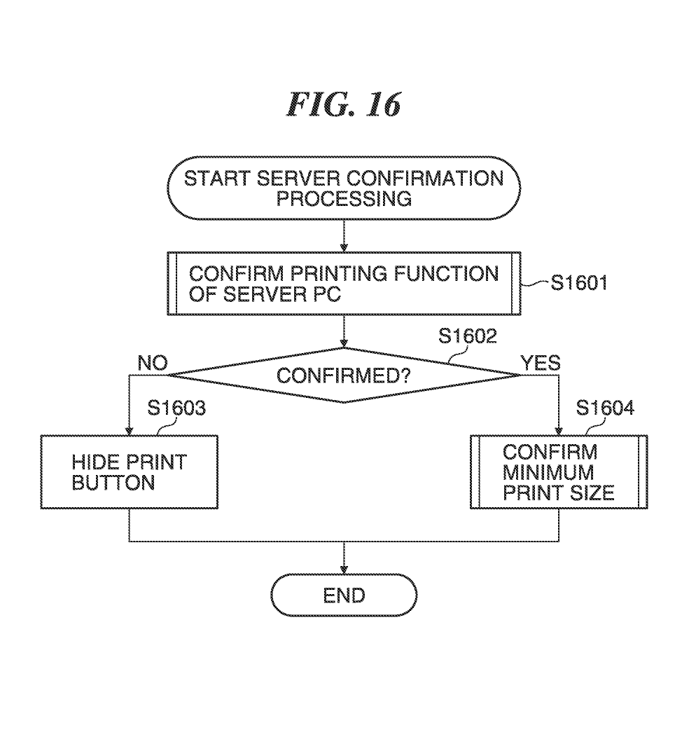

FIG. 16 is a flowchart for explaining confirmation processing for confirming the function of the server PC 110 performed at the camera 100 shown in FIG. 1. It should be noted that the processing according to the flowchart shown in the figure is performed before the edited moving image is displayed at the display 104.

When the confirmation processing is started, the CPU 105 confirms whether the server PC 110 has a function (printing function) of printing the material images using the composition information file (step S1601).

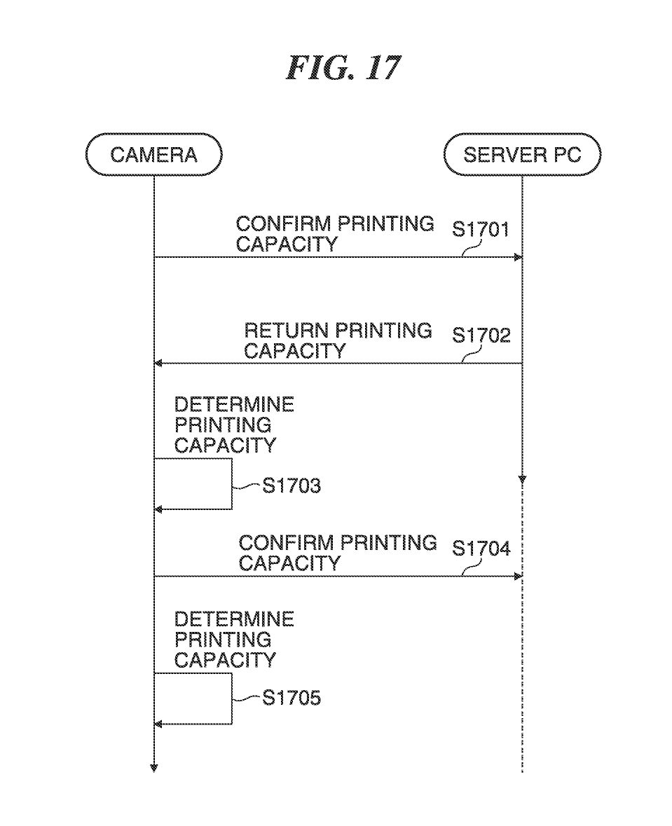

FIG. 17 is a diagram for explaining confirmation processing of the printing function of the server PC 110 shown in FIG. 16.

The CPU 105 performs confirmation of the printing function (hereinafter, also referred to as printing capacity) to the server PC 110 using the WiFi camera connection module 103 (step S1701). In response to the confirmation, the server PC 110 responds printing capacity to the camera 100 (step S1702).

When receiving the response from the server PC 110, the CPU 105 determines that the moving image can be printed at the server PC 110 (step S1703). Meanwhile, if the CPU 105 confirms the printing capacity while the server PC 110 is stopped (step S1704), because the server PC 110 does not respond, the CPU 105 determines that printing is impossible at the server PC 110 (step S1705).

Referring to FIG. 16 again, the CPU 105 determines whether or not the printing capacity of the server PC 110 can be confirmed (step S1602). If the printing capacity of the server PC 110 cannot be confirmed (step S1602: No), the CPU 105 hides the print button 1501 (step S1603). The CPU 105 then finishes the confirmation processing of the function of the server PC 110.

When the print button 1501 is hidden, as shown in FIG. 15B, the edited moving image according to the moving image file 1401 and the return button 1004 are displayed at the display 104.

When the printing capacity of the server PC 110 can be confirmed (step S1602: Yes), the CPU 105 confirms a minimum image size required for the server PC 110 to print a still image (step S1504).

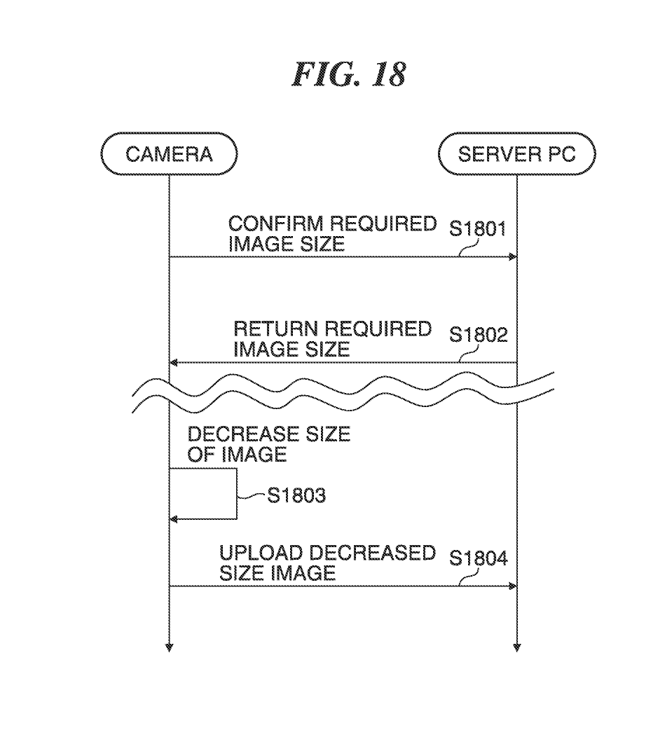

FIG. 18 is a diagram for explaining confirmation processing of a minimum image size required for the server PC 110 shown in FIG. 16.

When the confirmation processing of the minimum image size is started, the CPU 105 inquires about the minimum image size required to perform printing to the server PC 110 via the WiFi connection module 103 (step S1801). The server PC 110 transmits a response regarding the minimum image size to the camera 100 in response to the inquiry (step S1802).

The CPU 105 decreases the size of an image (material image) to be uploaded to the server PC 110 to the minimum image size (printable image size) according to the minimum image size in the response (step S1803) and uploads the image to the server PC 110 (step S1804). The CPU 105 then finishes the confirmation processing of the function of the server PC 110.

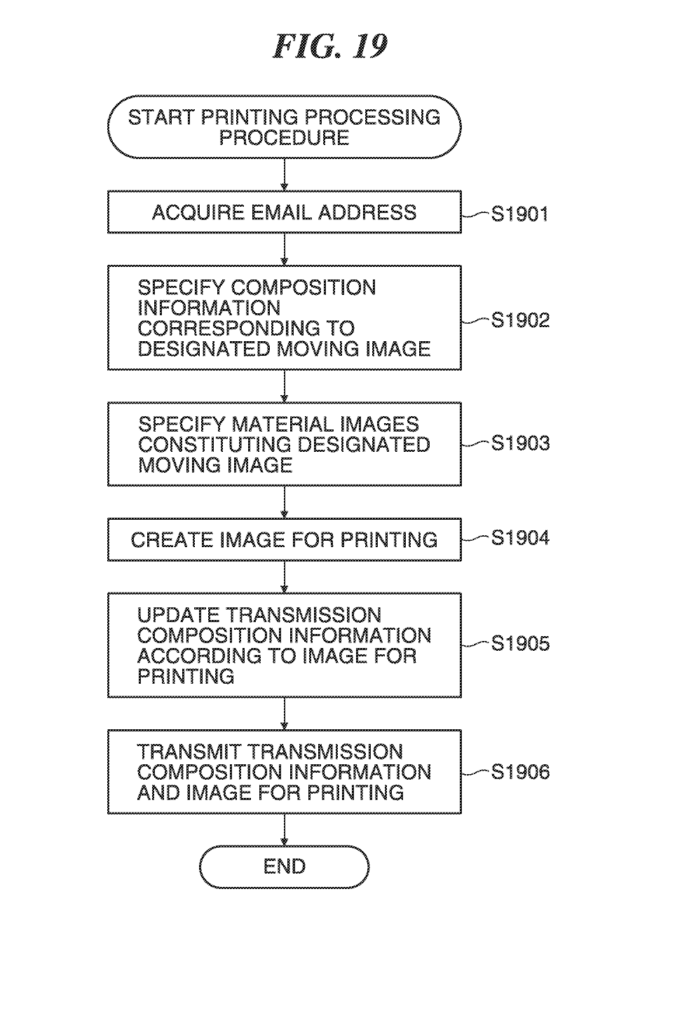

FIG. 19 is a flowchart for explaining an example of printing processing procedure performed at the camera 100 shown in FIG. 1.

Now, when the print button 1501 shown in FIG. 15A is pressed, the CPU 105 displays an email address screen shown in FIG. 15C at the display 104 (step S1901). By this means, the CPU 105 encourages the user to input an email address. The input email address is used to notify the user of completion of print layout data by the server PC 110.

When the user inputs the email address in an email address input field 1503 at the email address screen and presses an enter button 1504, input of the email address is completed. When input of the email address is completed, the CPU 105 specifies a composition information file corresponding to the edited moving image which is determined to be printed (step S1902).

Here, because the moving image file 1401 is printed, the CPU 105 specifies the composition information file 1402 corresponding to the moving image file 1401 in the SD card 101. That is, the CPU 105 specifies a file which is located in the same layer as the layer of the moving image file 1401 and which has the same file name other than the extension, as the composition information file 1402.

Subsequently, the CPU 105 specifies material images used in the moving image file 1401 with reference to the composition information file 1402 (step S1903). When specifying of the material images is completed, the CPU 105 generates images for printing from the material images (step S1904).

Here, if the material images include a moving image, the CPU 105 generates three still images for printing for the moving image. The CPU 105 then stores the still images in a layer where the original moving image is located. Upon storage of the still images, the CPU 105 uses a file name with an underscore and a segment number being added after the file name of the original moving image and an extension of JPG being added thereto.

For example, in the example shown in FIG. 14, still images 1404, 1405 and a still image 1406 are generated from the moving image 207 of a file name of MOV_0006.MP4. The file names of the still images 1404, 1405 and 1406 are respectively made MOV_0006_1.JPG, MOV_0006_2.JPG and MOV_0006_3.JPG.

It should be noted that when the minimum image size is obtained from the server PC 110 and the size of the material image is larger than the minimum image size, the CPU 105 decreases the size of the material image to the minimum image size.

Subsequently, the CPU 105 modifies the composition information file 1402 according to the images for printing to generate a transmission composition information file 1403. This transmission composition information file 1403 is stored in the same layer as the layer of the composition information file 1402. At this time, the CPU 105 sets a file name of the transmission composition information file 1403, in which NEW which is a prefix character of the file name of the composition information file 1402 is changed to PRT.

The CPU 105 then transmits the transmission composition information file 1403 corresponding to the moving image file 1401 determined to be printed, the images for printing corresponding to the transmission composition information file 1403, and the email address to the server PC 110 (step S1906). The CPU 105 then finishes the printing processing procedure.

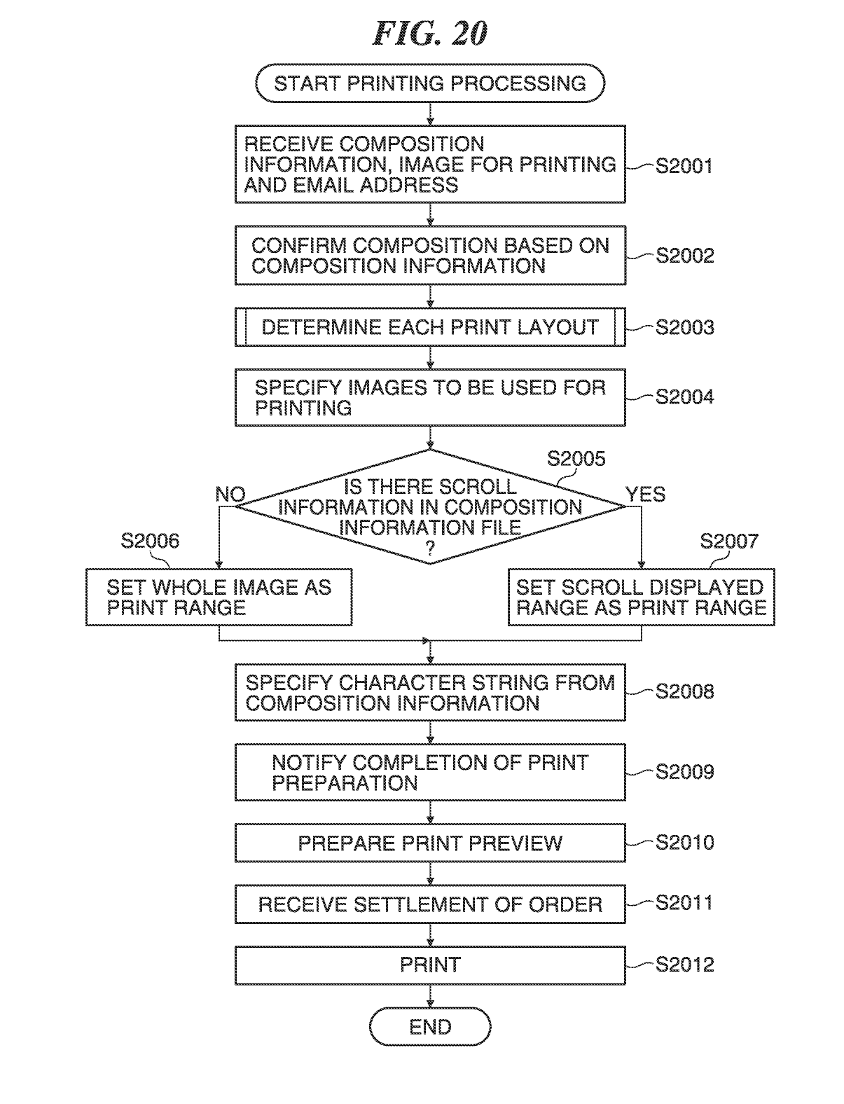

FIG. 20 is a flowchart for explaining printing processing performed at the server PC 110 shown in FIG. 1.

At the server PC 110, the CPU 114 receives the transmission composition information file 1403, the images for printing 201, 202, 203, 204, 205, 206, 208, 1404, 1405 and 1406 and the email address (step S2001).

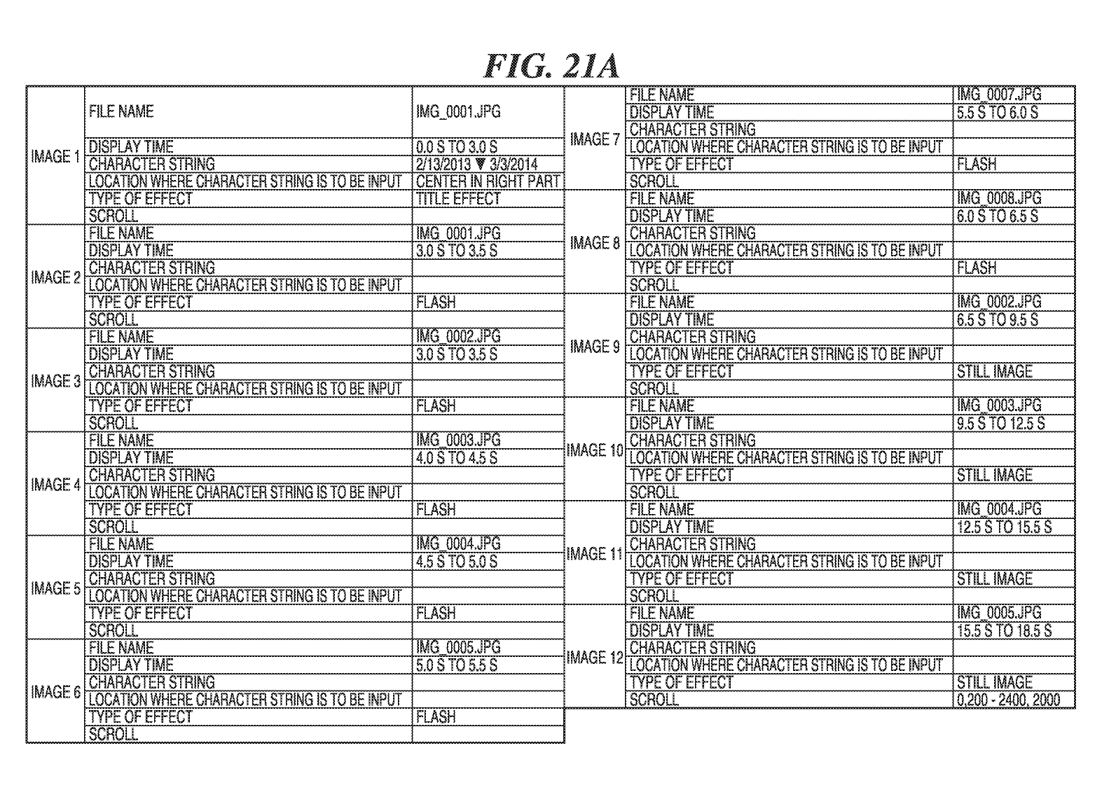

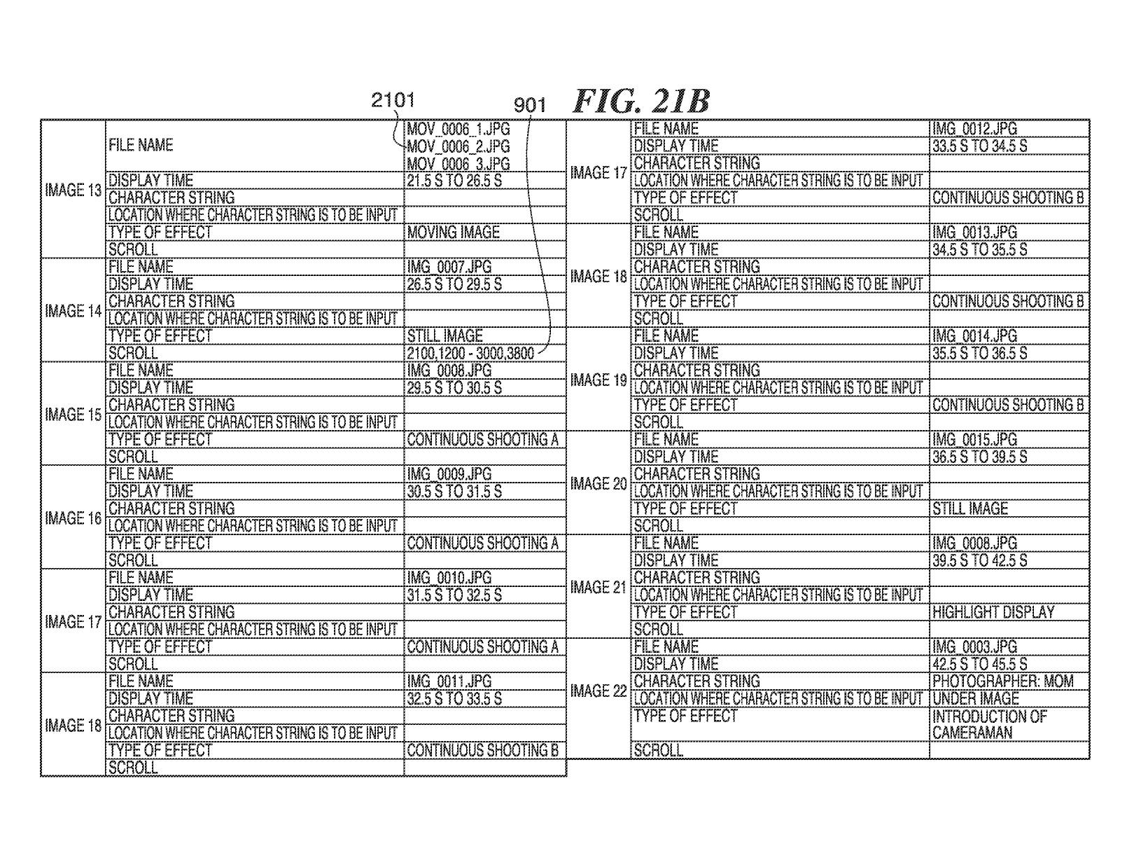

FIGS. 21A and 21B are diagrams showing the transmission composition information file received by the server PC 110 shown in FIG. 1.

In FIGS. 21A and 21B, the transmission composition information file is different from the composition information file shown in FIGS. 9A and 9B in an image 13. That is, while the file name of the image 13 is MOV_0006.MP4 in the composition information file shown in FIGS. 9A and 9B, the file name 2101 of the image 13 is MOV_0006_1.JPG, MOV_0006_2.JPG and MOV_0006_3.JPG as shown in FIGS. 21A and 21B, because, as described above, three still images for printing are generated for the moving image.

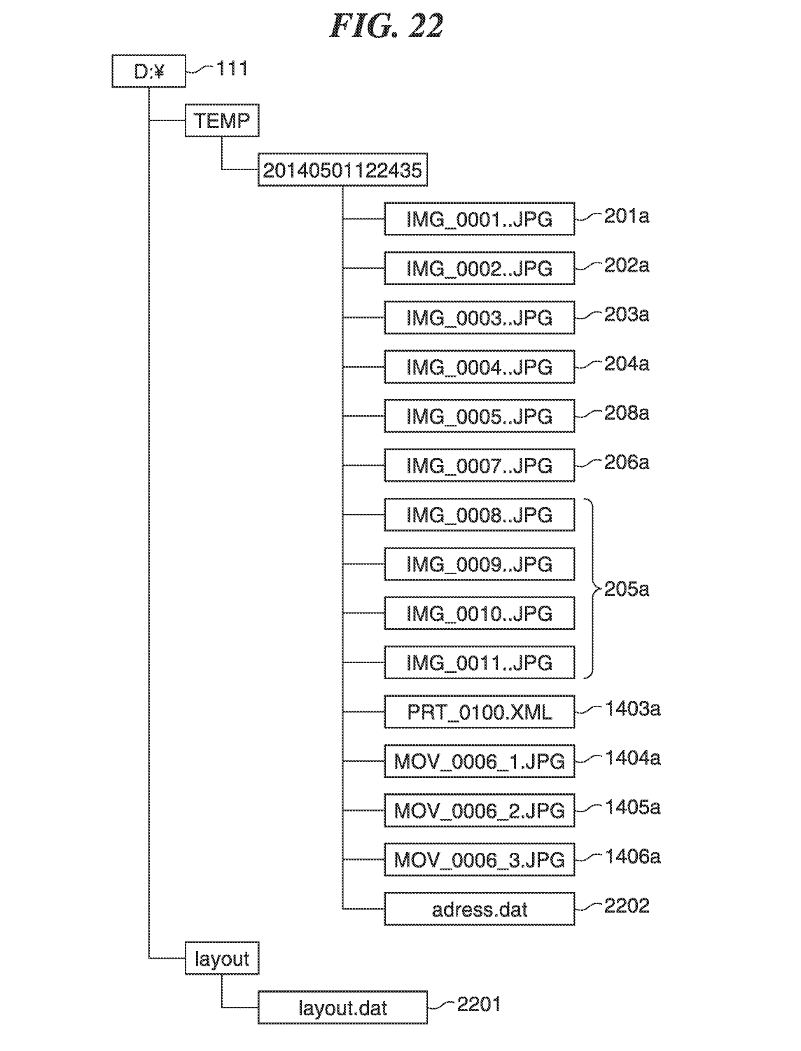

FIG. 22 is a diagram showing an example of the transmission composition information file, the images for printing and a registration destination of the email address received by the server PC 110 shown in FIG. 1.

The CPU 114 stores the transmission composition information file, the images for printing and the email address in the HDD 111. Here, the transmission composition information file and the images for printing are stored in the HDD 111 respectively as the transmission composition information file 1403a and the images for printing 201a to 204a, 208a, 206a and 205a.

At this time, the email address is described in an address file 2202 and stored in the HDD 111 as a file. Further, if the images for printing include a moving image, the CPU 114 divides the moving image into three parts having the same reproduction period. The CPU 114 then cuts out the first frames as still images to modify part of the moving image in the transmission composition information file. Further, the CPU 114 stores three still images in place of the moving image file.

Referring to FIG. 20 again, the CPU 114 analyzes the transmission composition information file 1403a to confirm how the moving image for which the user gives an instruction of printing is composed (step S2002). The CPU 114 then determines print layout (that is, page layout) for each of the images for printing (step S2003).

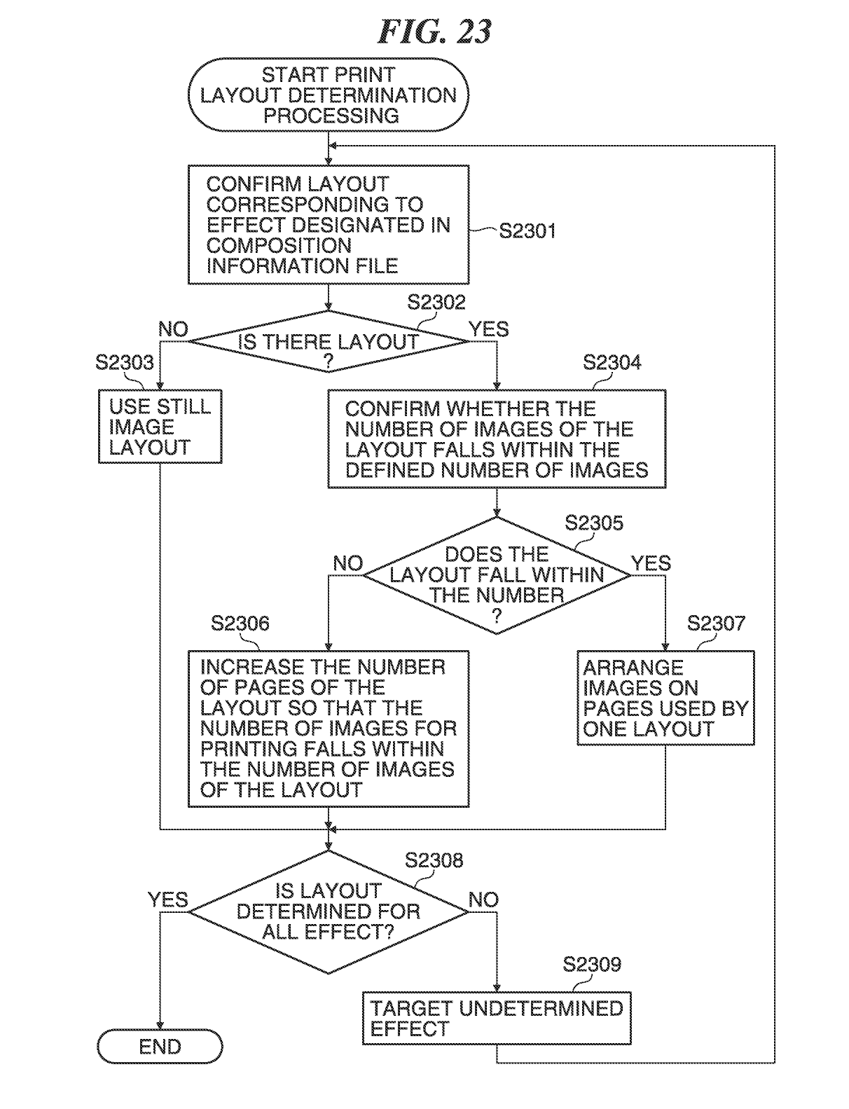

FIG. 23 is a diagram for explaining an example of determination processing of the print layout shown in FIG. 20.

When the determination processing of the print layout is started, the CPU 114 reads out effect information used for the material images based on the transmission composition information file. The CPU 114 then confirms whether or not there is page layout (hereinafter, also simply referred to as layout) corresponding to the effect information (step S2301).

In the HDD 111, as shown in FIG. 22, a print layout definition file (layout.dat) 2201 indicating whether or not there is layout is stored. The CPU 114 determines print layout corresponding to the effect information with reference to the print layout definition file 2201.

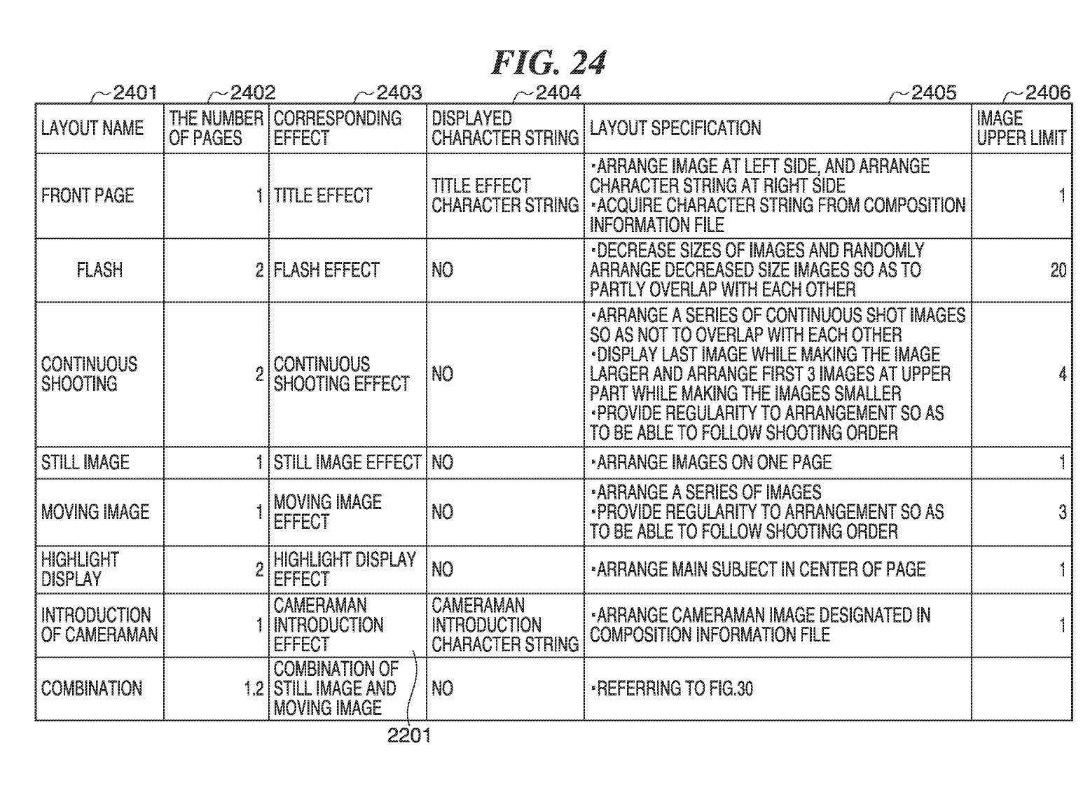

FIG. 24 is a diagram showing a structure of an example of the print layout definition file 2201 shown in FIG. 22.

In a layout name 2401, a name of the print layout is described, and the details are defined for each layout name. In the number of pages 2402, the number of pages used in each layout name is defined. In corresponding effect 2403, a name for each type of effect in the moving image which is designated to be printed is defined. The print layout for effect in which the effect name defined in the transmission composition information file 1403a matches the effect name of the corresponding effect 2403 is specified by comparing the effect name defined in the transmission composition information file 1403a and the effect name of the corresponding effect 2403.

In a displayed character string 2404, a character string to be displayed in each layout is defined. In layout specification 2405, how the images and the character string are arranged in each layout is defined.

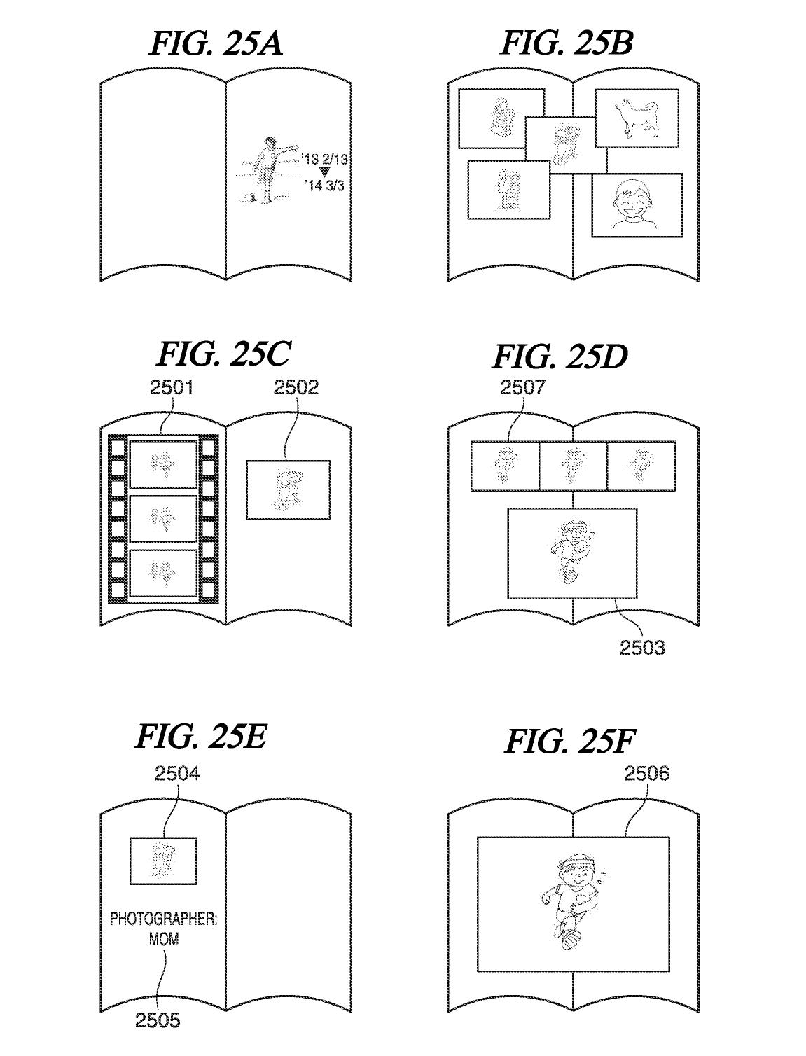

FIG. 25A is a diagram showing front page layout which is a result of the print layout processing performed at the server PC shown in FIG. 1. FIG. 25B is a diagram showing title effect layout which is a result of the print layout processing performed at the server PC shown in FIG. 1. FIG. 25C is a diagram showing still image effect layout and moving image effect layout which are results of the print layout processing performed at the server PC shown in FIG. 1. FIG. 25D is a diagram showing continuous shooting effect layout which is a result of the print layout processing performed at the server PC shown in FIG. 1. FIG. 25E is a diagram showing cameraman introduction effect layout which is a result of the print layout processing performed at the server PC shown in FIG. 1. FIG. 25F is a diagram showing highlight effect layout which is a result of the print layout processing performed at the server PC shown in FIG. 1.

In the example shown in the figure, when the image used for the title effect in the transmission composition information file 1403a is printed, the front page layout is selected from the print layout definition file 2201. Upon printing, one page is used, and the image and a character string for displaying the title effect are used. In a paper sheet, the image is arranged at a left side, and the character string is arranged at a right side of the image. By this means, the front page layout becomes layout, for example, shown in FIG. 25A.

Further, when the image used for flash effect is printed, the flash layout is selected from the print layout definition file 2201. Upon printing, two pages are used, and a plurality of pages of images are printed. At this time, a character string is not printed. Images are randomly arranged in two pages of paper sheets. By this means, the flash layout becomes layout, for example, shown in FIG. 25B.

When the image used for the continuous shooting effect (display switching effect) is printed, the continuous shooting layout is selected from the print layout definition file 2201. Upon printing, two pages are used, and a plurality of pages of images are printed. At this time, a character string is not printed. The images are arranged in order of shooting in two pages of paper sheets. By this means, continuous shooting effect layout becomes layout, for example, shown in FIG. 25D.

In the example shown in FIG. 25D, four images are used as a series of continuous shot images. The image shot last in the series of continuous shot images is arranged at a lower part in the center of two facing pages as shown in an image frame 2503. Further, images other than the image shot last are arranged in a predetermined direction at an upper part of the two facing pages as shown in an image frame 2507.

When the image used for still image effect is printed, the still image layout is selected from the print layout definition file 2201. Upon printing, one page is used, and one image is printed. At this time, a character string is not printed. The image is arranged in the center in one page of a paper sheet. By this means, still image effect layout becomes layout, for example, shown in an image frame 2502 in FIG. 25C.

When the image used for highlight display effect is printed, highlight display layout is selected from the print layout definition file 2201. Upon printing, two facing pages are used, and one image is printed. At this time, a character string is not printed. By this means, highlight display effect layout becomes layout, for example, shown in an image frame 2506 in FIG. 25F.

When the image used for cameraman introduction effect (photographer introduction effect) is printed, the cameraman introduction layout is selected from the print layout definition file 2201. Upon printing, one page is used, and one image and a character string are printed. By this means, cameraman introduction effect layout becomes layout, for example, shown in an image frame 2504 and a character string 2505 in FIG. 25E.

The effect of “combination of still image and moving image” shown in a bottom row of FIG. 24 designates, as the composition information, a usual still image and a moving image which is shot before or after automatically shooting the usual still image.

The combination of still image and moving image corresponds to a combination of the usual still image and still images extracted from the moving image which is shot before or after automatically shooting the usual still image.

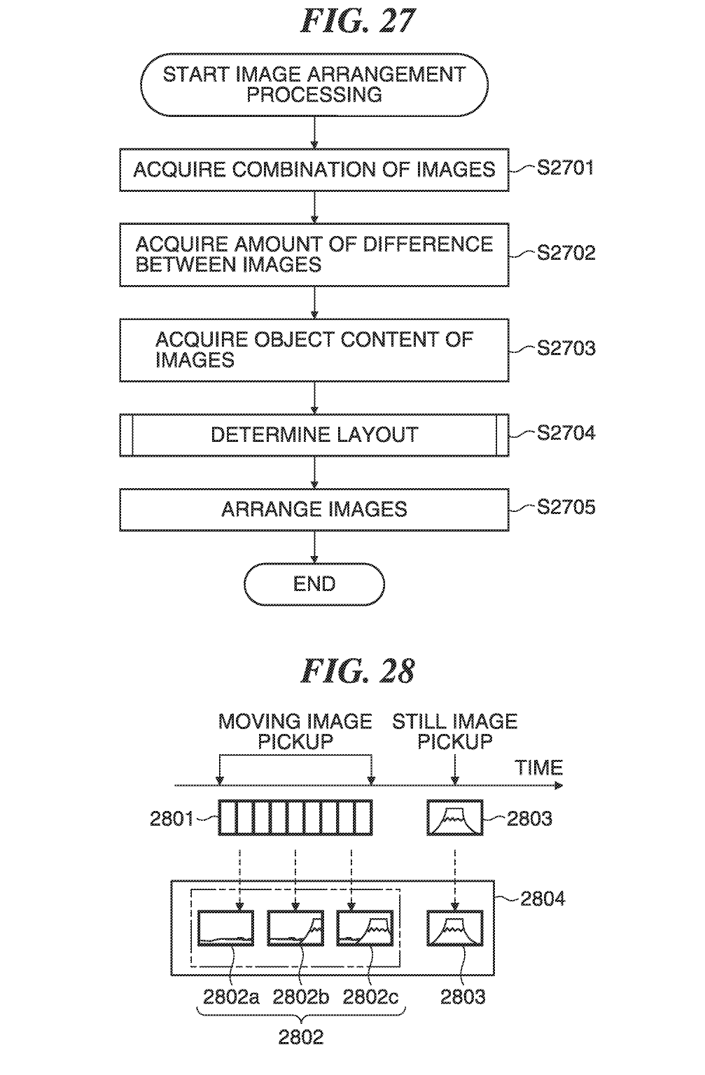

In a displaying effect, the still images extracted from the moving image which is shot before or after automatically shooting the usual still image are continuously displayed for a short time. After that, the usual image is widely displayed for a long time. A detailed description will be made in case of laying out such a moving image with reference to FIG. 27.

When the image used for moving image effect is printed, the moving image layout is selected from the print layout definition file 2201. Upon printing, one page is used, and a plurality of still images constituting the moving image are printed. At this time, a character string is not printed. The plurality of images are arranged in a longitudinal direction in order of shooting in one page of a paper sheet. By this means, moving image effect layout becomes layout, for example, shown in an image frame 2501 in FIG. 25C.

Referring to FIG. 23 again, the CPU 114 determines whether or not there is layout corresponding to the print layout definition file 2201 (step S2302). If there is no corresponding layout (step S2302: No), the CPU 114 uses layout for still images (step S2303).

If there is corresponding layout (step S2302: Yes), the CPU 114 confirms whether the number of images for printing falls within the number of images defined in the layout (step S2304). It should be noted that the upper limit number of images is defined in an image upper limit 2406 in the print layout definition file 2201.

The CPU 114 then determines whether or not the number of images for printing falls within the number of images (upper limit number of images) defined in the corresponding layout (step S2305). If the number of images for printing does not fall within the number of images defined in the corresponding layout (step S2305: No), the CPU 114 integrally multiplies the required number of pages for printing in the corresponding layout so that all the images for printing can be arranged (step S2306). That is, the CPU 114 increases the number of pages in the layout so that the number of material images per page is equal to or less than the upper limit number of images.

Meanwhile, if the number of images for printing falls within the number of images defined in the corresponding layout (step S2305: Yes), the CPU 114 secures required pages for printing in the corresponding layout (step S2307).

After the processing of step S2303, S2306 or S2307, the CPU 114 determines whether or not layout is determined for all effect (step S2308). If layout is determined for all effect (step S2308: Yes), the CPU 114 finishes the print layout determination processing.

Meanwhile, if layout is not determined for all effect (step S2308: No), the CPU 114 targets undetermined effect (step S2309). The CPU 114 then returns to the processing of step S2301. It should be noted that even if the type of effect is the same, if the images largely differ in the shooting period or the shooting target, and the images are defined as different groups in the transmission composition information file, layout is determined for each group.

Referring to FIG. 20 again, when the print layout determination processing is finished as described above, the CPU 114 specifies an image to be used for printing (step S2004). It should be noted that the image to be used for printing is defined in the transmission composition information file 1403a. The image to be used for printing is stored in the same layer as the layer of the transmission composition information file 1403a.

Subsequently, the CPU 114 determines whether or not a material image is scroll displayed in the moving image with reference to the transmission composition information file 1403a (step S2005). If the material image is not scroll displayed (step S2005: No), the CPU 114 sets the whole material image as a print range (step S2206).

Meanwhile, if the material image is scroll displayed (step S2005: Yes), the CPU 114 sets only part of the material image displayed in the moving image as the print range (step S2007).

As shown in FIGS. 21A and 21B, there is a case where a scroll displayed range is defined in the transmission composition information file 1403a depending on the material image. For example, because a scroll position 901 is designated in the image 14 in FIGS. 21A and 21B, when the image 14 is printed, the whole material image is not set as the print range, but only a range designated by the scroll position 901 (that is, a partial image corresponding to the display range) is set as the print range. It should be noted that the print range is determined so that the size of a print target region becomes maximum in the determined print layout range.

After the processing of step S2006 or S2007, the CPU 114 acquires a character string for layout required to be printed from the transmission composition information file 1403a (step S2008). Here, because it can be known that the transmission composition information file 1403a includes title effect, title layout which is layout for title effect is used.

In the title layout, a character string is printed along with the image, the CPU 114 acquires a character string to be used in the title effect from the transmission composition information file 1403a. Here, a character string 902 shown in FIGS. 9A and 9B is used as the character string of the title layout.

Subsequently, the CPU 114 notifies the camera 100 of completion of printing preparation (step S2009). This notification is performed toward the email address received in the above-described step S2001.

After issuing a notification of completion of printing preparation, the CPU 114 prepares a print preview (step S2010). This print preview is print data for performing printing, and used by the user to confirm a print result before printing. After receiving the notification of completion of printing preparation at the camera 100, the user accesses the server PC 111 through a Web browser using the camera 100. By this means, the user can open a print preview confirmation screen.

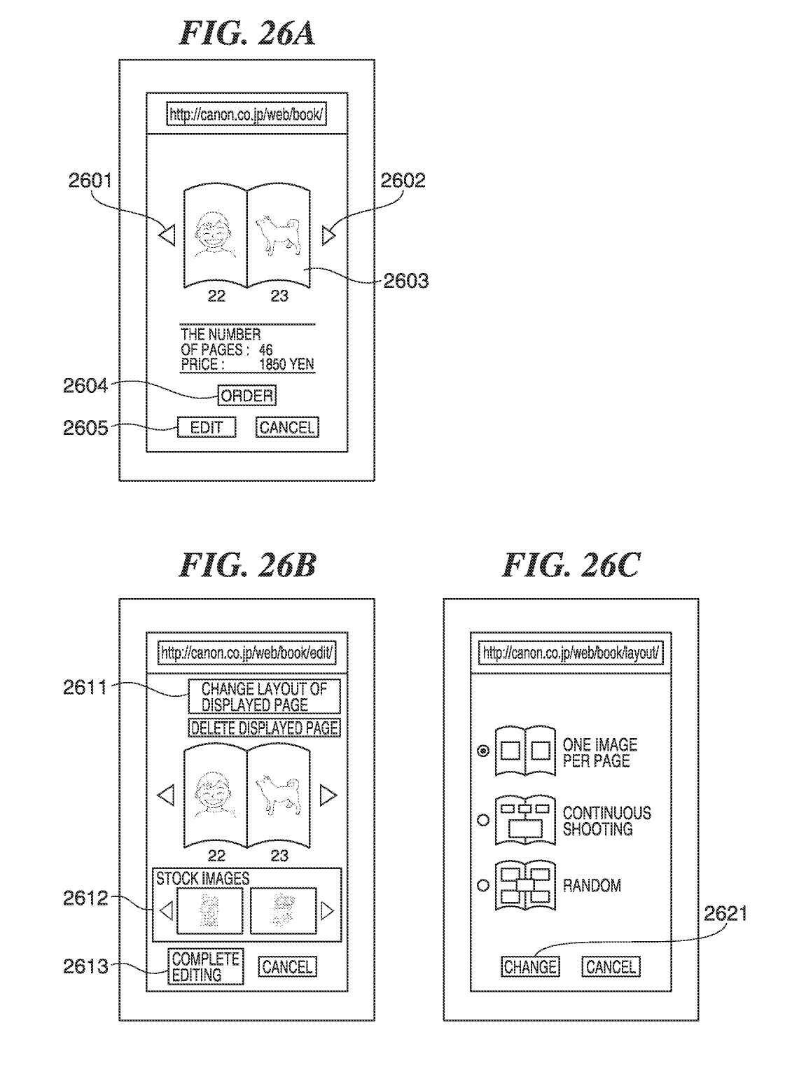

FIG. 26A is a diagram showing an example of the print preview confirmation screen which can be viewed at the camera shown in FIG. 1. Further, FIG. 26B is a diagram showing an example of an editing screen which can be viewed at the camera shown in FIG. 1. Still further, FIG. 26C is a diagram showing an example of a layout switching screen which can be viewed at the camera shown in FIG. 1.

In the print preview confirmation screen shown in FIG. 26A, a return button 2601 and a forward button 2602 are displayed, and by manipulation of the return button 2601, a preview page returns to the previous page. Further, by manipulation of the forward button 2602, the preview page forwards to the subsequent page. That is, by manipulation of the return button 2601 or the forward button 2602, the page of the print preview 2603 can be changed.

Further, in the print preview confirmation screen, an order button 2604 is displayed, and, if the user confirms and satisfies the print preview 2603, the user can order the printed matter as a book by manipulating the order button 2604.

Meanwhile, if the user confirms the print preview 2603 and desires to change content to be printed, the user can perform editing by manipulating an editing button 2605.

When the editing button 2605 is pressed, the editing screen shown in FIG. 26B is displayed at the display 104 at the camera 100. On this editing screen, an editing completion button 2613 is displayed, and, when the user finishes editing and presses the editing completion button 2613, a print preview confirmation screen after editing is displayed at the display 104 (see FIG. 26A).

Further, on the editing screen, a stock image field 2612 is displayed, and if the user uses an image other than the images used in the print preview 2603, the user can select an image from the stock image field 2612 and drop the image to the print preview 2603.

It should be noted that, the images arranged in the stock image field 2612 are, for example, images uploaded to the server PC 110 when the moving image was previously printed at the camera 100. Further, the images arranged in the stock image field 2612 may be images acquired from social networking service other than the server PC 110.

Further, on the editing screen, a layout change button 2611 for changing layout of the displayed page is displayed. When the layout change button 2611 is pressed, a screen shown in FIG. 26C is displayed at the display 104.

On the screen shown in FIG. 26C, the user can designate switching to another layout. The user designates layout to be switched to and presses a change button 2621. By this means, layout of the designated page is switched in the print preview 2603.

If the number of images required for the switched layout is larger than the number of images required for the layout prior to switching, the CPU 114 instructs the user to select insufficient images from the stock image field 2612 by the CPU 105. Meanwhile, if the number of images required for the switched layout is smaller than the number of images required for the layout prior to switching, the CPU 114 determines images to be used according to the date and time of shooting (for example, in order of date and time of shooting).

Referring to FIG. 20 again, after presenting the print preview 2603 to the user, the CPU 114 waits for the user to settle printing. When the user presses the order button 2604 to settle the order, the CPU 114 accepts the order (step S2011). Subsequently, the CPU 114 transmits payment information relating to payment, or the like, to a payment page of a credit card company. When the CPU 114 receives notification of completion of payment from the credit card company, the CPU 114 controls the printer 150 via the USB terminal 115 to execute printing relating to the order (step S2012). When printing is completed, the CPU 114 finishes the printing processing.

FIG. 27 is a flowchart for explaining an example of image arrangement processing using an effect of the combination of a still image and a moving image, which is performed at the server PC shown in FIG. 1. It should be noted that the processing relating to the flowchart shown in the figure is performed by the CPU 114 executing a program stored in the HDD 111.

When the image arrangement processing is started, the CPU 114 acquires a combination of images to be laid out on a page of an album as will be described later based on the moving image and still images stored in the HDD 111 (step S2701).

FIG. 28 is a diagram showing distribution of images used in the image arrangement processing shown in FIG. 27.

FIG. 28 shows an example of a combination of images creating the page and shows a still image and still images extracted from the moving image which has been automatically picked up before the still image was picked up. Here, at the camera 100, a moving image 2801 is picked up for a predetermined period, for example, four seconds before a still image 1803 was picked up. The CPU 105 extracts, for example, still images 2802a to 2802c at equal time intervals from the moving image 2801. The CPU 105 stores a group 2804 in which these still images 2802a to 2802c and the still image 2803 are combined in the SD card 101.

It should be noted that the combination of images of the group 2804 may be one other than that as described above. For example, the combination may be a combination of still images selected from still images obtained through continuous shooting or a combination of still images selected or extracted from image information under predetermined conditions. Further, the still image 2802 which will be described below is any one or a plurality of the still images 2802a to 2802c extracted from the moving image 2801.

The above-described group 2804 is transmitted from the camera 100 to the server PC 110. At the server PC 110, the CPU 114 stores the group 2804 in the HDD 111 as the moving image and the still images.

The CPU 114 acquires an amount of difference between the images in the group 2804 (step S2702). For example, the CPU 114 calculates respective amounts of difference between the still images 2802a to 2802c extracted from the moving image 2801 and the still image 2803 and sets an average value of the amounts as the amount of difference of the group 2804. For example, the CPU 114 creates thumbnail images of the same size for the still images 2802a to 2802c and 2803 and calculates an amount of difference between the thumbnail images. As the amount of difference, for example, a change amount of the thumbnail images, a change amount in predetermined regions of the thumbnail images, sizes of the thumbnail images, a difference in characteristic amounts of the thumbnail images or a difference in color tone (color temperature, color shade, intensity) of the thumbnail images is used.

Subsequently, the CPU 114 acquires object content of the still images 2802a to 2802c and 2803 (step S2703). For example, the CPU 114 performs object recognition processing on the still images 2802a to 2802c and 2803 and acquires content of objects, that is, a type of the subject. The CPU 114 identifies, as a type of the subject, whether or not there is a person in the objects included in the still images 2802a to 2802c and 2803 using a person detection method used in the known image processing. The person detection method includes, for example, a method using a brightness gradient direction histogram characteristic amount which is obtained by displaying a brightness gradient direction in each region of the objects included in the still images 2802a to 2802c and 2803 in a histogram.

As will be described later, the CPU 114 determines layout of the group 2804 (step S2704). The CPU 114 then creates a page by laying out the still images 2802a to 2802c and 2803 according to the layout determined in the processing of step S2704 (step S2705). Subsequently, the CPU 114 finishes the image arrangement processing.

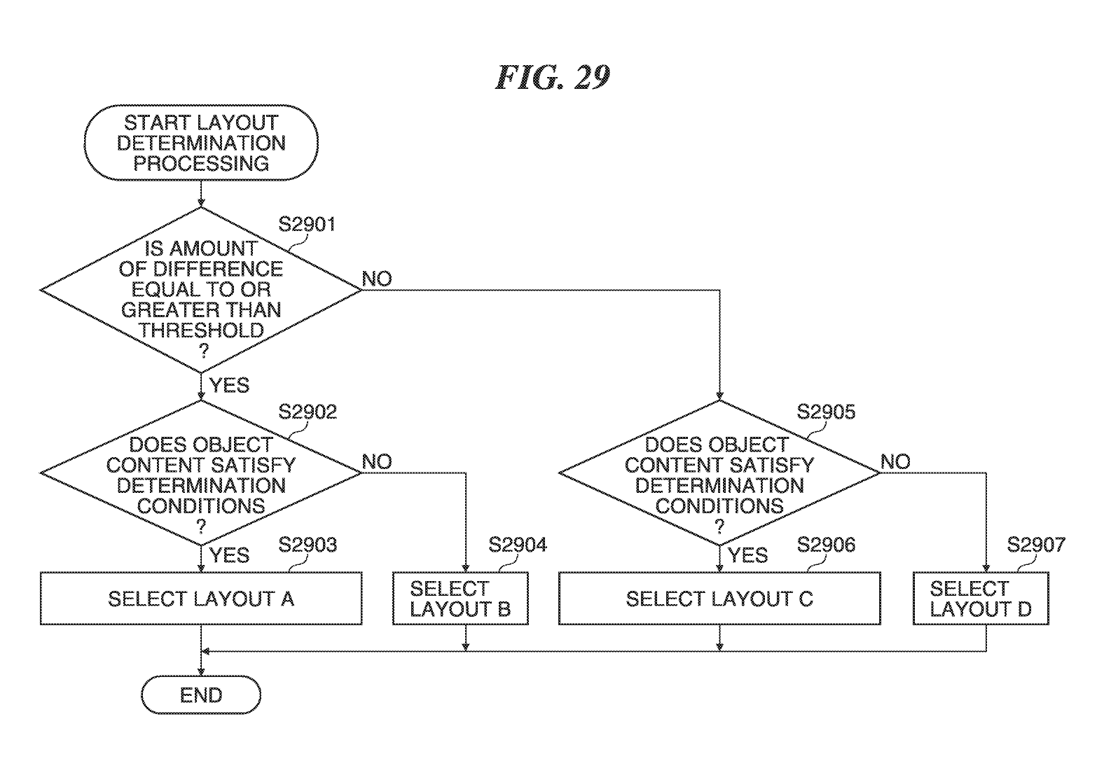

FIG. 29 is a flowchart for explaining the layout determination processing shown in FIG. 27.

When the layout determination processing is started, the CPU 114 determines whether or not the amount of difference of the group 2804 acquired in the processing of step S2702 is equal to or greater than a predetermined threshold (step S2901). As this threshold, for example, an amount of difference at which the still images 2802a to 2802c are not similar to the still image 2803 may be set. When the amount of difference is equal to greater than the predetermined threshold (step S2901: Yes), the CPU 114 determines that the still images 2802a to 2802c are not similar to the still image 2803. The CPU 114 then determines whether or not the object content acquired in the processing of step S2703 satisfies predetermined determination conditions (step S2902). In the processing of step S2902, the CPU 114 uses whether or not there is a person in the image of the group 2804 as the determination conditions.

When the object content satisfies the determination conditions (step S2902: Yes), the CPU 114 determines that there is a person in the image of the group 2804 and selects layout A which will be described later (step S2903). The CPU 114 then finishes the layout determination processing. Meanwhile, if the object content does not satisfy the determination conditions (step S2902: No), the CPU 114 determines that there is no person in the image of the group 2804 and selects layout B which will be described later (step S2904). The CPU 114 then finishes the layout determination processing.

When the amount of difference is less than the predetermined threshold (step S2901: No), the CPU 114 determines that the still images 2802a to 2802c are similar to the still image 2803. The CPU 114 then determines whether or not the object content acquired in step S2703 satisfies the determination conditions (step S2905). If the object content satisfies the determination conditions (step S2905: Yes), the CPU 114 determines that there is a person in the image of the group 2804 and selects layout C which will be described later (step S2906). The CPU 114 then finishes the layout determination processing. Meanwhile, if the object content does not satisfy the determination conditions (step S2905: No), the CPU 114 determines that there is no person in the image of the group 2804 and selects layout D which will be described later (step S2907). The CPU 114 then finishes the layout determination processing.

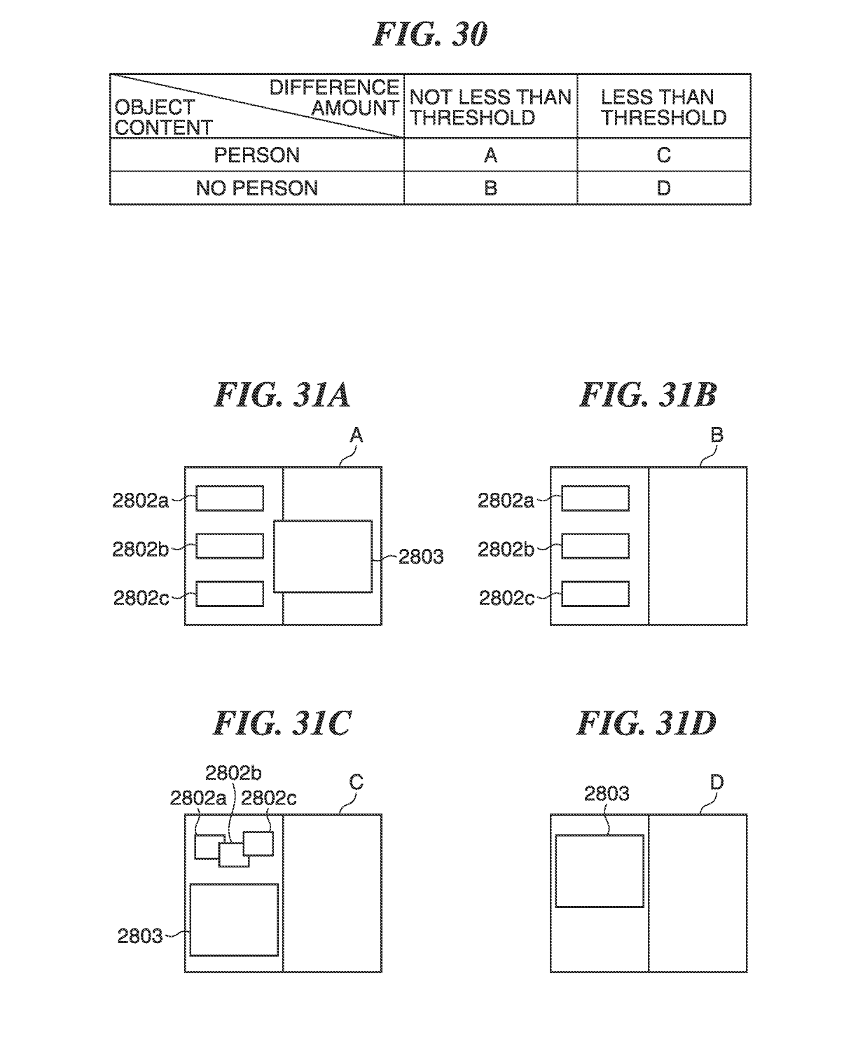

FIG. 30 shows Table 1 indicating layout selected by the CPU 114 as described above.

FIG. 31A to FIG. 31D are diagrams showing examples of types of layout determined in the layout determination processing shown in FIG. 29.

FIG. 31A shows an example of the layout A. When selecting the layout A, the CPU 114 lays out the still images 2802a to 2802c in a longitudinal direction in the figure. The CPU 114 then lays out the still image 2803 while making the still image 2803 larger than the still images 2802a to 2802c.

FIG. 31B shows an example of the layout B. When selecting the layout B, the CPU 114 lays out the still images 2802a to 2802c in a longitudinal direction in the figure. The CPU 114 then does not lay out the still image 2803 in which there is no person.

FIG. 31C shows an example of the layout C. When selecting the layout C, the CPU 114 lays out the still images 2802a to 2802c in time series in a lateral direction while making the still images 2802a to 2802c smaller than those in the layout A and B. The CPU 114 then lays out the still image 2803 while making the still image 2803 larger.

FIG. 31D shows an example of the layout D. When selecting the layout D, the CPU 114 lays out only the still image 2803.

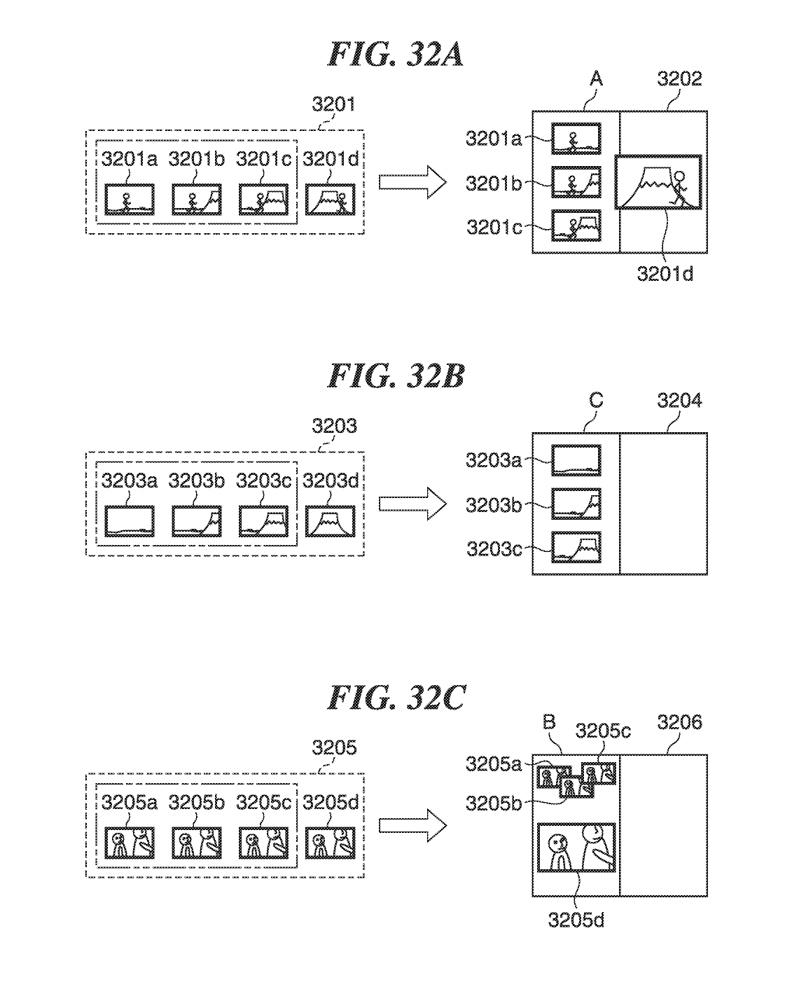

FIG. 32A to FIG. 32C are diagrams showing arrangement of images according to the layout determined in the layout determination processing shown in FIG. 29.

FIG. 32A, FIG. 32B and FIG. 32C show layout of pages respectively generated using the groups 3201, 3203 and 3205. In the example shown in FIG. 32A, the group 3201 has an amount of difference equal to or greater than the predetermined threshold and has object content which satisfies the determination conditions. That is, the still images 3201a to 3201d include persons. Therefore, the CPU 114 arranges the still images 3201a to 3201c extracted from the moving image in a longitudinal direction using the layout A. Further, the CPU 114 generates a page 3202 by laying out the still image 3201d while making the still image 3201d larger.

It should be noted that, while, in the group 3201, all the still images 3201a to 3201d include persons, for example, when there is no person in any of the still images 3201a to 3201d, a still image which includes a person may be laid out at a position of the still image 3201d of the page 3202. Then, the remaining still images may be respectively laid out at positions of 3201a to 3201c.

In the example shown in FIG. 32B, the group 3203 has an amount of difference equal to or greater than the predetermined threshold and the object content which does not satisfy the determination conditions. That is, the still images 3203a to 3203d do not include a person. Therefore, the CPU 114 arranges only the still images 3203a to 3203c extracted from the moving image in a longitudinal direction using the layout B and generates a page 3204 using layout from which the still image 3203d is excluded.

In the example shown in FIG. 32C, the group 3205 has an amount of difference less than the predetermined threshold and the object content which satisfies the determination conditions. That is, the still images 3205a to 3205d include persons. Therefore, the CPU 114 lays out the still images 3205a to 3205c extracted from the moving image using the layout while making the still images 3205a to 3205c smaller and making the still images 3205a to 3205c look like a moving image. Further, the CPU 114 generates a page 3206 using layout in which the still image 3205d is laid out while making the still image 3205d larger.

As described above, because a plurality of images are combined, and layout is determined based on the image information, it is possible to set layout appropriate for the combination of the still images. Further, if similar still images are combined, it is possible to avoid similar images from being arranged by excluding similar images from the layout.

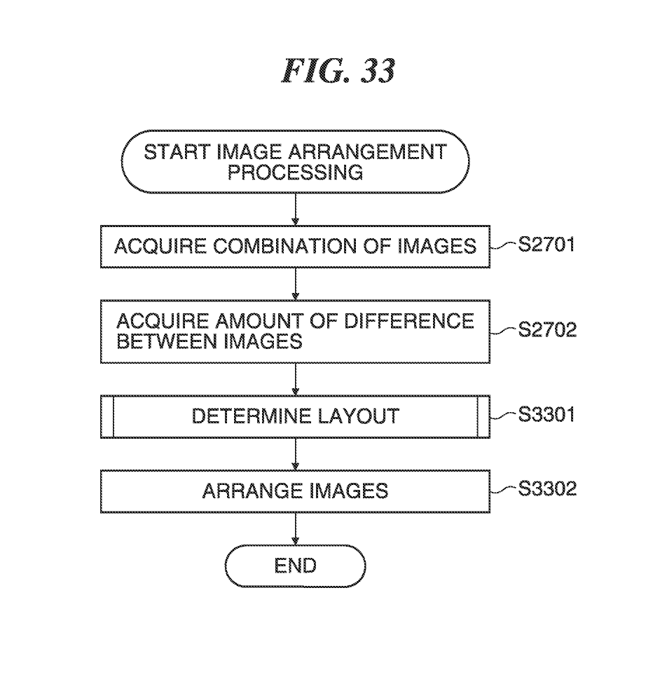

FIG. 33 is a flowchart for explaining another example of the image arrangement processing performed at the server PC shown in FIG. 1. It should be noted that, in FIG. 33, the same reference numerals are assigned to the same steps as those in the flowchart shown in FIG. 27, and the explanation thereof will be omitted.

After the processing of step S2702, the CPU 114 determines layout of the still images included in the group 2804 as will be described later (step S3301). The CPU 114 then generates a page by laying out the still images 2802a to 2802c and 2803 based on the layout determined in step S3301.

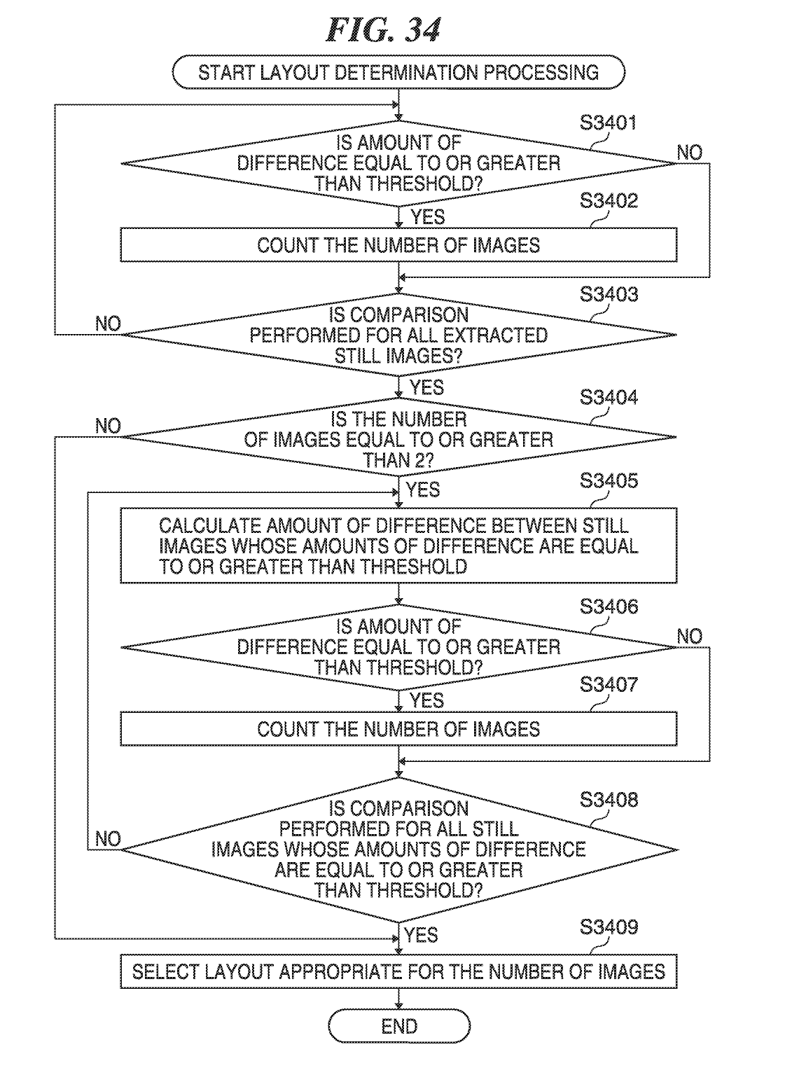

FIG. 34 is a flowchart for explaining the layout determination processing shown in FIG. 33.

When the layout determination processing is started, the CPU 114 determines whether or not an amount of difference of one of the still images 2802a to 2802c acquired in step S2702 is equal to or greater than the predetermined threshold (step S3401). When the amount of difference is equal to or greater than the predetermined threshold (step S3401: Yes), the CPU 114 determines that the images are not similar images. The CPU 114 then counts the number of still images whose amount of difference is equal to or greater than the threshold (step S3402). It should be noted that, in step S3402, an initial value of the number of images is “0”.

Subsequently, the CPU 114 determines whether or not the amount of difference is compared with the predetermined threshold for all the still images 2802a to 2802c (step S3403). When the amount of difference is compared with the predetermined threshold for all the still images 2802a to 2802c (step S3403: No), the CPU 114 returns to the processing of step S3401. It should be noted that if the amount of difference is less than the predetermined threshold (step S3401: No), the CPU 114 determines that the images are similar images, and proceeds to the processing in step S3403.

When the amount of difference is compared with the predetermined threshold for all the still images 2802a to 2802c (step S3403: Yes), the CPU 114 determines that the number of still images whose amounts of difference are equal to or greater than the predetermined threshold is acquired. The CPU 114 then determines whether or not the number of images counted in the processing of step S3402 is equal to or greater than two (step S3404). If the number of images is equal to or greater than two (step S3404: Yes), the CPU 114 determines that the amounts of difference in the still images whose amounts of difference are equal to or greater than the predetermined threshold can be calculated. The CPU 114 then calculates amounts of difference for the still images whose amounts of difference are determined to be equal to or greater than the predetermined threshold in the processing of step S3401 (step S3405).

Subsequently, the CPU 114 determines whether or not the amounts of difference calculated in step S3405 are equal to or greater than the predetermined threshold (step S3406). If the amounts of difference are equal to or greater than the predetermined threshold (step S3406: Yes), the CPU 114 determines that the still images whose amounts of difference are determined to be equal to or greater than the predetermined threshold in step S3401 are not similar images. The CPU 114 then counts the number of images whose amounts of difference exceed the threshold (step S3407). In step S3407, an initial value of the number of images is “1”.

Subsequently, the CPU 114 determines whether or not the amount of difference is compared with the predetermined threshold for all the still images for which the amounts of difference are determined to be equal to or greater than the threshold in step S3401 (step S3408). It should be noted that if the amount of difference is less than the threshold (step S3406: No), the CPU 114 determines that the still images for which the amounts of difference are determined to be equal to or greater than the predetermined threshold in step S3401 are similar images, and proceeds to the processing of step S3408.

When the amount of difference is not compared with the predetermined threshold for all the still images whose amounts of difference are equal to or greater than the predetermined threshold (step S3408: No), the CPU 114 determines that the number of still images whose amounts of difference are equal to or greater than the threshold has not been acquired, and returns to the processing of step S3405. Meanwhile, if the amount of difference is compared with the predetermined threshold for all the still images whose amounts of difference are equal to or greater than the threshold (step S3408: Yes), the CPU 114 determines that counting of the number of images whose amounts of difference are equal to or greater than the predetermined threshold is finished. The CPU 114 then selects layout appropriate for the number of images acquired in step S3402 and step S3407 (step S3409). The CPU 114 then finishes the layout determination processing. It should be noted that if the number of images is less than two (step S3404: No), the CPU 114 proceeds to the processing of step S3409.

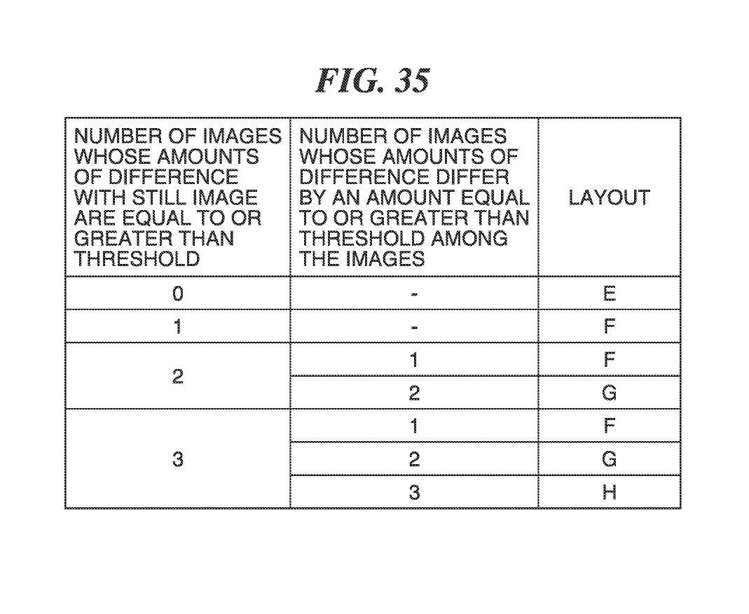

FIG. 35 shows Table 2 for explaining types of layout selected by the CPU 114 illustrated in FIG. 1.

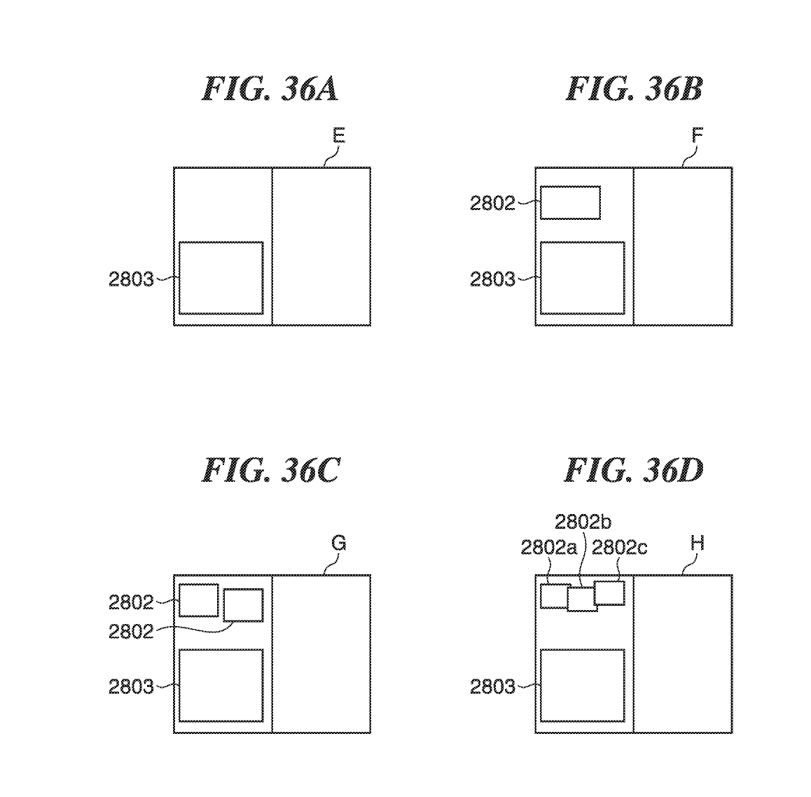

FIG. 36A to FIG. 36D are diagrams showing examples of types of layout determined in the layout determination processing shown in FIG. 34. Here, description will be provided using the group 2804 comprised of three still images 2802a to 2802c extracted from the moving image 2801 and one picked up still image 2803 as an example.

In the still images 2802a to 2802c and the still image 2803, if the number of images whose amounts of difference are equal to or greater than the predetermined threshold is “0”, the CPU 114 selects layout E in which the still image 2803 is arranged as shown in FIG. 36A. If there is a possibility that similar images may be arranged when the still images 2802a to 2802c and 2803 whose amounts of differences are less than the predetermined threshold are laid out, the CPU 114 selects layout E in which only the still image 2803 is laid out. When the number of images whose amounts of difference are equal to or greater than the predetermined threshold is “1” in each of the still images 2802a to 2802c and the still image 2803, as shown in FIG. 36B, the CPU 114 selects layout F in which the still image 2803 and one still image 2802 whose amount of difference is equal to or greater than the predetermined threshold are placed.

When the number of images whose amounts of difference with the still image 2803 are equal to or greater than the predetermined threshold is “2”, the CPU 114 acquires the amounts of difference of these two still images 2802. If the amounts of difference of the two still images 2802 are less than the predetermined threshold, the CPU 114 selects layout F in which the still image 2803 and one still image 2802 whose amount of difference with the still image 2803 is equal to or greater than the predetermined threshold are arranged. Because the amounts of difference of these two still images 2802 are less than the predetermined threshold, the CPU 114 determines that there is no great change in the two still images 2802. Therefore, as described above, the CPU 114 selects one still image 2802 out of the two still images 2802 whose amounts of difference with the still image 2803 are equal to or greater than the predetermined threshold. Further, any image may be used if the image has an amount of difference with the still image 2803 equal to or greater than the predetermined threshold.

If the amounts of difference of the two still images 2802 whose amounts of difference with the still image 2803 are equal to or greater than the predetermined threshold are equal to or greater than the predetermined threshold, the CPU 114 selects layout G in which the still image 2803 and the two still images 2802 whose amounts of difference with the still image 2803 are equal to or greater than the predetermined threshold are arranged (see FIG. 36C).

If the number of images whose amounts of difference with the still image 2803 are equal to or greater than the predetermined threshold is “3”, the CPU 114 acquires the amounts of difference of these three still images 2802a to 2802c and acquires the number of images whose amounts of difference are equal to or greater than the predetermined threshold in these three still images 2802a to 2802c. When the number of images whose amounts of difference are equal to or greater than the predetermined threshold is “1”, the CPU 114 selects layout F in which one of the still images 2802a to 2802c and the still image 2803 are arranged. When the number of images whose amounts of difference are equal to or greater than the predetermined threshold is “2”, the CPU 114 selects layout G in which two still images whose amounts of difference are equal to or greater than the predetermined threshold and the still image 2803 are arranged. When the number of images whose amounts of difference are equal to or greater than the predetermined threshold is “3”, the CPU 114 selects layout H in which the still images 2802a to 2802c whose amounts of difference are equal to or greater than the predetermined threshold and the still image 2803 are arranged (see FIG. 36D).

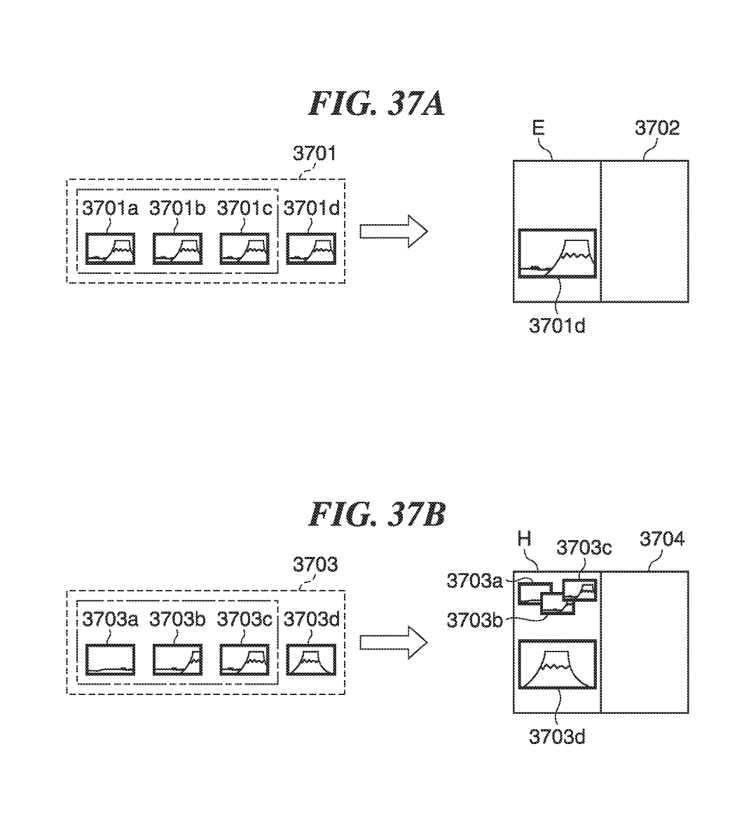

FIG. 37A and FIG. 37B are diagrams showing arrangement of images according to the layout determined in the layout determination processing shown in FIG. 34.

FIG. 37A and FIG. 37B show layout of pages generated respectively using a group 3701 and a group 3703. In the example shown in FIG. 37A, in the group 3701, the amounts of difference between the still images 3701a to 3701c and the still image 3701d are all less than the threshold. That is, the still images 3701a to 3701d included in the group 3701 are combination of similar images. Therefore, the CPU 114 generates a page 3702 by laying out only the still image 3701d using the layout E.

In the example shown in FIG. 37B, in the group 3703, the amounts of difference between the still images 3703a to 3703c and the still image 3703d are equal to or greater than the threshold, and the amounts of difference among the still images 3703a to 3703c differ by an amount equal to or greater than the predetermined threshold. That is, because the amounts of difference of the still images 3703a to 3703d included in the group 3703 differ from each other by an amount equal to or greater than the predetermined threshold, the CPU 114 generates a page 3704 by selecting the layout H in which the still image 3703d is arranged while the still image 3703d is made larger and the still images 3703a to 3703c are arranged.

As described above, because the amounts of difference of the still images are used, it is possible to determine layout appropriate for combination of the images.

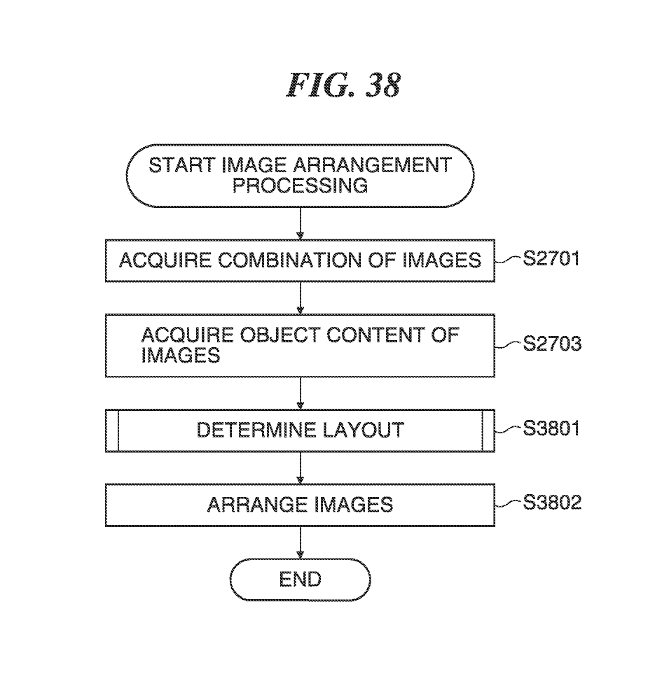

FIG. 38 is a flowchart for explaining still another example of the image arrangement processing performed at the server PC shown in FIG. 1. It should be noted that in FIG. 38, the same reference numerals are assigned to the same steps as those in the flowchart shown in FIG. 27, and the explanation thereof will be omitted.

After the processing of step S2701, the CPU 114 performs the processing of step S2703 described using FIG. 27. The CPU 114 then determines layout of the still images included in the group 2804 as will be described later (step S3801). The CPU 114 then generate a page by laying out the still images 2802a to 2802c and 2803 based on the layout determined in step S3801.

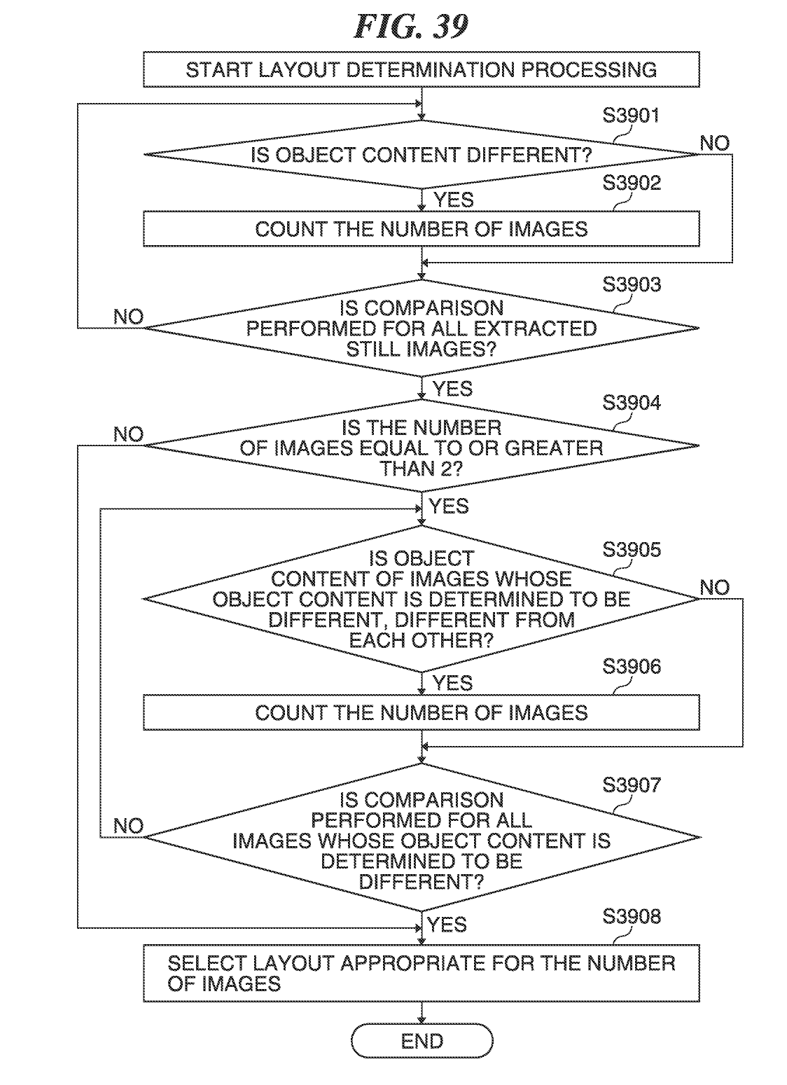

FIG. 39 is a flowchart for explaining the layout determination processing shown in FIG. 38.

When the layout determination processing is started, the CPU 114 compares the object content of the still images 2802a to 2802c acquired in step S2701 with the object content of the still image 2803 to determine whether or not the object content is different (step S3901). Here, the number of persons included in the still images 2802a, 2802b and 2802c and the still image 2803 is regarded as the object content. When the number of persons included in the still image 2803 is different from the number of persons included in the still images 2802a, 2802b and 2802c (step S3901: Yes), the CPU 114 determines that these still images are not similar images. The CPU 114 then counts the number of still images 2802 whose number of persons is different from that of the still image 2803 (step S3902). It should be noted that, in step S3902, an initial value of the number of images is “0”.

Subsequently, the CPU 114 determines whether or not the object content of all the still images 2802a to 2802c is compared with the object content of the still image 2803 (step S3903). If the object content of all the still images 2802a to 2802c is not compared with the object content of the still image 2803 (step S3903: No), the CPU 114 returns to the processing of step S3901. It should be noted that, if the number of persons is the same (step S3901: No), the CPU 114 determines that the images are similar images, and proceeds to the processing of step S3903.

If the object content of all the still images 2802a to 2802c is compared with the object content of the still image 2803 (step S3903: Yes), the CPU 114 determines that the number of still images whose number of persons is different is acquired. The CPU 114 then determines whether or not the number of images counted in the processing of step S3902 is two or more (step S3904). If the number of images is two or more (step S3904: Yes), the CPU 114 determines that the object content can be compared among the still images 2802 whose object content is different. The CPU 114 then determines whether or not the object content is different among the still images 2802 whose object content is determined to be different in the processing of step S3901 (step S3905).

If the object content is different among the still images 2802 (step S3905: Yes), the CPU 114 counts the number of images whose object content is different (step S3906). It should be noted that an initial value of the number of images in step S3906 is 1. The CPU 114 then determines whether or not the object content of all the still images 2802 whose object content is determined to be different in step S3901 is compared (step S3907). If the object content of all the still images 2802 is compared (step S3903: Yes), the CPU 114 selects layout appropriate for the number of images obtained in step S3902 and step S3906 (step S3908). Subsequently, the CPU 114 finishes the layout determination processing.

If the object content is the same among the still images 2802 (step S3905: No), the CPU 114 proceeds to the processing of step S3907. If the object content of all the still images 2802 is not compared (step S3907: No), the CPU 114 determines that the number of persons included in the still images 2802 is the same, and returns to the processing of step S3905.

In step S3904, if the number of images is less than “2” (step S3904: No), the CPU 114 determines that the object content cannot be compared among the still images 2802 whose object content is different, and proceeds to the processing of step S3908.

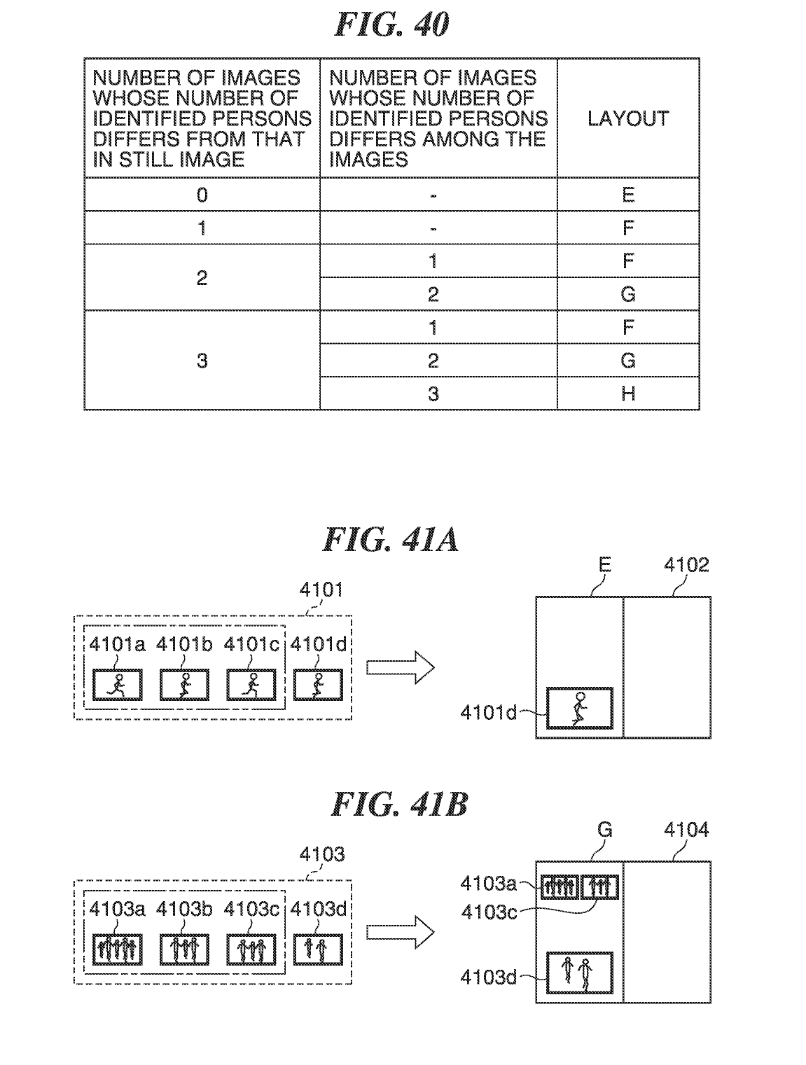

FIG. 40 shows Table 3 for explaining types of layout selected by the CPU 114 illustrated in FIG. 1.

The layout E to H indicated in Table 3 is the same as the layout indicated in Table 2. Here, description will be provided using a group 2804 comprised of three still images 2802a to 2802c extracted from the moving image 2801 and one picked up still image 2803 as an example. In the still images 2802a to 2802c and the still image 2803, if the number of images whose number of persons is different from that of the still image 2803 is “0”, the CPU 114 selects the layout E in which the still image 2803 is arranged. If the number of images whose number of persons is different from that of the still image 2803 is “1”, the CPU 114 selects the layout F in which the still image 2803 and the still image 2802 whose number of persons is different from that of the still image 2803 are arranged.

If the number of images whose number of persons is different from that of the still image 2803 is “2”, the CPU 114 compares the number of persons included in these two still images 2802. If the number of persons included in the two still images 2802 is the same, the CPU 114 selects the layout F in which the still image 2803 and one of the two still images 2802 are arranged. Meanwhile, if the number of persons included in the two still images 2802 is different from each other, the CPU 114 selects the layout G in which the still image 2803 and the two still images 2802 are arranged.

If the number of images whose number of persons is different from that of the still image 2803 is “3”, the CPU 114 compares the number of persons among these three still images 2802a to 2802c. If the number of images whose number of persons is different among the three still images 2802a to 2802c is “1”, the CPU 114 selects the layout F in which one of the still images 2802a to 2802c and the still image 2803 are arranged. It should be noted that if the number of images whose number of persons is different is “0”, the number of persons in the still images 2802a to 2802c is the same.

If the number of images whose number of persons is different among the still images 2802a to 2802c is “2”, the CPU 114 selects the layout G in which the two still images 2802 whose number of persons is different and the still image 2803 are arranged. If the number of images whose number of persons is different among the still images 2802a to 2802c is “3”, the CPU 114 selects the layout H in which the still images 2802a to 2802c and the still image 2803 are arranged.

FIG. 41A and FIG. 41B are diagrams showing arrangement of the images according to the layout determined in the layout determination processing shown in FIG. 39.

FIG. 41A and FIG. 41B show layout of pages generated respectively using the group 4101 and the group 4103. In the example shown in FIG. 41A, in the group 4101, the number of persons identified in the still images 4101a to 4101d is the same. That is, the still images 4101a to 4101d included in the group 4101 are combination of similar images. Therefore, the CPU 114 generates a page 4102 by laying out only the still image 4101d using the layout E.

In the example shown in FIG. 41B, the number of persons identified in two still images is different among the still images 4103a to 4103c extracted from the moving image. Therefore, the CPU 114 generates a page 4104 by selecting the layout G and arranging the still image 4103d while making the still image 4103d larger and arranging the still images 4103a and 4103c for which the identified number of persons is different. It should be noted that among the still images 4103a to 4103c extracted from the moving image, because the number of persons identified in the still images 3803b and 4103c is the same, the still image 4103b may be used in place of the still image 4103c as the image laid out in the page 4104.

As described above, because the layout is determined based on the object content identified in the plurality of still images, it is possible to determine layout appropriate for the combination of the images.

It should be noted that, while, in the above-described example, the object content is determined according to whether or not there is a person in the still image, the object content is not limited to a person. For example, the object content may be determined according to whether or not there is an authenticated person or whether or not there is a person who is focused on. Further, the object content may be determined according to whether or not the still image is a favorite image or whether or not there is a specific object other than a person. In this case, when a person is authenticated, the person is authenticated using a known face authentication method. Further, concerning a person who is focused on, determination is performed according to whether or not an image is picked up while the person is focused on upon image pickup. Still further, concerning whether or not the still image is a favorite image, determination is performed using a known rating.

In the known face authentication method, for example, a position of the face is detected from the image, and each characteristic part of the face is detected. Then, a person is authenticated by performing normalization processing of adjusting an angle, or the like, based on the position of each part and checking the face against face templates which have been already registered. Further, the rating is, for example, a numerical value set for the image using a function of application for image processing.

Further, while, in the above-described example, still images are extracted from the moving image which is automatically picked up before the still images are picked up, still images may be extracted from a moving image which is picked up after the still images are picked up. Further, while, in the above-described example, layout held by the server PC is selected, the CPU 114 may generate layout which satisfies the determination conditions according to programmed processing.

Further, while, in the example shown in FIG. 1, the server PC 110 is connected to the printer 150 via the USB terminal 115, if the printer can connect to a network, the printer may print a moving image directly sent from the camera 100. That is, while, in the example shown in FIG. 1, the camera 100 is an image pickup apparatus and the server PC 110 and the printer 150 are print control apparatuses, only the printer which can connect to a network may be the print control apparatus.

Further, the smartphone 120 shown in FIG. 1 may be used as the image pickup apparatus, so that an image for printing, or the like, are transmitted from the smartphone 120 to the server PC 110 in a similar manner to the camera 100. At this time, the smartphone 120 is not connected to the printer 150.

Further, the smartphone 120 may be used as the print control apparatus, so that an image for printing, or the like, are transmitted from the camera 100 to the smartphone 120. The smartphone 120 prints a moving image using the printer 150 in a similar manner to the server PC 110.

As described above, according to the embodiment of the present invention, even when still images are printed using a moving image, the user can easily recognize content expressed with the moving image which is a printing source, from the still images obtained through printing.

As is clear from the above description, in the example shown in FIG. 1, the camera 100 is the image processing apparatus, and the CPU 105 and the button 106 function as a designating unit. Further, the CPU 105 functions as an image specifying unit, while the CPU 105 and the WiFi connection module 103 function as transmitting units. Still further, the CPU 105 functions as an image size decreasing unit, a moving image generating unit, a composition information generating unit and a recording unit.

Further, the server PC 110 is a print control apparatus, and the CPU 114 and the HDD 11 function as storage units, the CPU 114 functions as a layout determining unit and a print data generating unit. Further, the CPU 114 and the HDD 111 function as memory units, and the CPU 114 and the network board 113 function as a receiving unit, a notifying unit, a preview transmitting unit, an editing unit and a print control unit. It should be noted that the print control apparatus may transmit print data to the remotely located printer 150 via a wired or wireless network and give an instruction of printing, or may incorporate the printer 150.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2014-210650 filed Oct. 15, 2014 and No. 2015-124698 filed June 22, which are hereby incorporated by reference herein in its entirety.

What is claimed is:

1. An image processing apparatus comprising:
a designating unit configured to designate a moving image as a print target;
an image specifying unit configured to specify a material image to be printed based on composition information associated with the moving image designated as the print target by said designating unit, the composition information including information for specifying a plurality of original images used for generating the moving image; and
a transmitting unit configured to transmit the material image specified by said image specifying unit and the composition information to a print control apparatus to instruct the print control apparatus to perform printing.

2. The image processing apparatus according to claim 1, wherein, when the original images are moving images, said image specifying unit generates a still image used as the material image from the moving images which are the original images.

3. The image processing apparatus according to claim 1, further comprising an image size decreasing unit configured to decrease a size of the material image according to a size of an image which can be printed by the print control apparatus,
wherein said transmitting unit transmits the material image whose size is decreased by said image size decreasing unit to the print control apparatus.

4. The image processing apparatus according to claim 1, wherein said transmitting unit transmits the composition information and the material image to the print control apparatus via a network.

5. The image processing apparatus according to claim 1, further comprising:
a moving image generating unit configured to generate a moving image using a plurality of images; and
a composition information generating unit configured to generate composition information including information for specifying the original images used for generating the moving image at said moving image generating unit.

6. The image processing apparatus according to claim 1, wherein the composition information comprises information for specifying a type of effect applied when the moving image is generated.

7. The image processing apparatus according to claim 1, further comprising:
an image pickup unit; and
a recording unit configured to record an image obtained by said image pickup unit in a recording medium as a still image or a moving image.

8. A print control apparatus comprising:
a storage unit configured to store composition information including information for specifying a type of effect applied when a moving image is generated and a material image to be printed;
a layout determining unit configured to determine layout of a page of a printed matter according to the information for specifying the type of effect included in the composition information; and
a print data generating unit configured to generate print data by arranging the material image based on the layout of the page.

9. The print control apparatus according to claim 8, further comprising a memory unit configured to store information for defining the layout of the page according to the type of effect.

10. The print control apparatus according to claim 8, further comprising:
a receiving unit configured to receive the composition information and the material image from the image processing apparatus; and
a notifying unit configured to notify the image processing apparatus when generation of the print data by said print data generating unit is completed or when printing is completed.

11. The print control apparatus according to claim 10, further comprising a preview transmitting unit configured to transmit the print data generated by said print data generating unit to the image processing apparatus as a print preview.

12. The print control apparatus according to claim 11, further comprising an editing unit configured to, when print layout is changed or the material image is changed in the image processing apparatus according to the print preview, edit the print data based on the change.

13. The print control apparatus according to claim 10, further comprising a print control unit configured to perform printing according to the print data when a payment completion notification indicating that payment is performed is received at the image processing apparatus.

14. The print control apparatus according to claim 8, wherein the composition information includes information for specifying a plurality of original images used for generating the moving image.

15. The print control apparatus according to claim 8, wherein, when the composition information includes a display range for scroll displaying the material image, said print data generating unit sets a partial image corresponding to the display range as a print target region.

16. The print control apparatus according to claim 8, wherein
the types of effect include a type of moving image effect and a type of continuous shooting effect, and
when there is the type of moving image effect or the type of continuous shooting effect, said layout determining unit determines the layout of the page of the printed matter by arranging the material image in a predetermined direction.

17. The print control apparatus according to claim 8, wherein
the types of effect include a type of display switching effect, and
when there is the type of display switching effect, said layout determining unit determines the layout of the page of the printed matter by arranging the material image in a predetermined direction over one page or two pages while decreasing the size of the material image.

18. The print control apparatus according to claim 8, wherein
the types of effect include a type of highlight display effect, and
when there is the type of highlight display effect, said layout determining unit determines the layout of the page of the printed matter while increasing the size of the material image.

19. The print control apparatus according to claim 8, wherein
the types of effect include a type of photographer introduction effect for introducing a photographer who shoots the material image, and
when there is the type of photographer introduction effect, said layout determining unit determines the layout of the page of the printed matter by adding a character string for introducing the photographer.

20. The print control apparatus according to claim 8, wherein, when the number of material images per page exceeds a predetermined upper limit number of images in print layout for the material images having the same type of effect, said layout determining unit increases the number of pages in the print layout for the material images having the same type of effect so that the number of material images per page is equal to or smaller than the upper limit number of images.

21. The print control apparatus according to claim 8, wherein the composition information includes information specifying an usual still image and a moving image which is automatically shot before or after shooting the usual still image.

22. The print control apparatus according to claim 8, wherein the a layout determining unit changes the layout in accordance with whether or not each of the still image and the moving image includes a person, in case where the composition information includes information specifying the usual still image and the moving image which is automatically shot before or after shooting the usual still image.

23. The print control apparatus according to claim 22, wherein the layout determining unit changes the layout in accordance with the amount of difference between the usual still image and a still image extracted from the moving image which is automatically shot before or after shooting the usual still image.

24. A control method of an image processing apparatus, comprising:
a designating step of designating a moving image as a print target;
an image specifying step of specifying a material image to be printed based on composition information associated with the moving image designated as the print target in said designating step, the composition information including information for specifying a plurality of original images used for generating the moving image; and
a transmitting step of transmitting the material image specified in said image specifying step and the composition information to a print control apparatus to instruct the print control apparatus to perform printing.

25. A control method of a print control apparatus, comprising:
a storage step of storing composition information including information for specifying a type of effect applied when a moving image is generated and a material image to be printed in a memory;
a layout determining step of determining layout of a page of a printed matter according to the information for specifying the type of effect included in the composition information; and
a print data generating step of generating print data by arranging the material image based on the layout of the page.

26. A computer-readable non-transitory storage medium storing a program for causing a computer to execute a control method of an image processing apparatus, the control method comprising:
a designating step of designating a moving image as a print target;
an image specifying step of specifying a material image to be printed based on composition information associated with the moving image designated as the print target in said designating step, the composition information including information for specifying a plurality of original images used for generating the moving image; and
a transmitting step of transmitting the material image specified in said image specifying step and the composition information to a print control apparatus to instruct the print control apparatus to perform printing.

27. A computer-readable non-transitory storage medium storing a program for causing a computer to execute a control method of a print control apparatus, the control method comprising:
a storage step of storing composition information including information for specifying a type of effect applied when a moving image is generated and a material image to be printed in a memory;
a layout determining step of determining layout of a page of a printed matter according to the information for specifying the type of effect included in the composition information; and
a print data generating step of generating print data by arranging the material image based on the layout of the page.
